(19) United States
(12) Patent Application Publication
(10) Pub. No.: US 2011/0080547 A1
(43) Pub. Date: Apr. 7, 2011

(54) LIQUID CRYSTAL DISPLAY DEVICE

(76) Inventors: Masaki MATSUMORI, Naka-gun (JP); Yasushi Tomioka, Hitachinaka (JP)

(21) Appl. No.: 12/889,460

(22) Filed: Sep. 24, 2010

(30) Foreign Application Priority Data
Oct. 1, 2009 (JP) 2009-229980

(51) Int. Cl. G02F 1/1337

(52) U.S. Cl. 349/124

(57) ABSTRACT

Provided is a liquid crystal display device including: a pair of substrates, at least one of which is transparent; a liquid crystal layer arranged between the pair of substrates; an electrode group formed on at least one of the pair of substrates, for applying an electric field to the liquid crystal layer; and an alignment control film arranged on at least one of the pair of substrates, in which the alignment control film is made of a polyimide and a polyimide precursor, and the polyimide and the polyimide precursor have an aromatic ring and a cross-linking moiety in the main chain in chemical structure, are free from a side chain component having 2 or more carbon atoms in the aromatic ring, contain a cyclobutanetetracarboxylic dianhydride as a raw material, and are irradiated with light that has been substantially linearly polarized to provide an alignment regulating force.

### CROSS-REFERENCE TO RELATED APPLICATION

The present application claims priority from Japanese application JP2009-229980 filed on Oct. 1, 2009, the content of which is hereby incorporated by reference into this application.

### BACKGROUND OF THE INVENTION

1. Field of the Invention

The present invention relates to a liquid crystal display device.

2. Description of the Related Art

As the related art, WO2005/083504 discloses the following technology.

The technology relates to a liquid crystal aligning agent for obtaining a liquid crystal alignment film excellent in not only liquid crystal alignment capability but also electrical properties through photoalignment procedure; and a liquid crystal display device making use of this liquid crystal aligning agent, which can resolve problems invited by rubbing treatment of liquid crystal alignment film, exhibiting high reliability and which can minimize display unevenness and exudation around sealing material. The technology also relates to a liquid crystal aligning agent for photoalignment, characterized by containing at least one of a polyamic acid, the polyamic acid obtained by allowing a diamine component containing a diamine component to react with a tetracarboxylic dianhydride component containing a tetracarboxylic dianhydride with an alicyclic structure into a polymer, and a polyimide obtained from the polyamic acid, and a liquid crystal display device having a liquid crystal alignment film obtained from the liquid crystal aligning agent through photoalignment procedure.

Further, JP 2001-517719 A discloses a technology relating to novel cross-linkable, photo active polymers from the class of polyimides, polyamide acids, and esters thereof and to their use as orientation layers for liquid crystals and in the construction of unstructured and structured optical elements and multi-layer systems.

### SUMMARY OF THE INVENTION

An object of the present invention is to provide a liquid crystal display device with a reduced residual image. The foregoing and other objects, features, aspects, and advantages of the present invention become more apparent from the description of the present application and the accompanying drawings.

A liquid crystal display device includes: a pair of substrates, at least one of which is transparent; a liquid crystal layer arranged between the pair of substrates; an electrode group formed on at least one of the pair of substrates, for applying an electric field to the liquid crystal layer; and an alignment control film arranged on at least one of the pair of substrates, in which the alignment control film is made of a polyimide and a polyimide precursor, and the polyimide and the polyimide precursor have an aromatic ring and a cross-linking moiety in the main chain in chemical structure, are free from a side chain component having 2 or more carbon atoms in the aromatic ring, contain a cyclobutanetetracarboxylic dianhydride as a raw material, and are irradiated with light that has been substantially linearly polarized to provide an alignment regulating force.

A liquid crystal display device includes: a pair of substrates, at least one of which is transparent; a liquid crystal layer arranged between the pair of substrates; an electrode group formed on at least one of the pair of substrates, for applying an electric field to the liquid crystal layer; and an alignment control film arranged on at least one of the pair of substrates, in which the alignment control film is made of a polyimide and a polyimide precursor, and the polyimide and the polyimide precursor include, as raw materials, at least one kind of diamine selected from a group of compounds I represented by the following chemical formulae (I-1) to (I-10), at least one kind of diamine selected from a group of compounds II represented by the following chemical formulae (II-1) to (II-15), and a cyclobutanetetracarboxylic dianhydride as an acid anhydride, and are irradiated with light that has been substantially linearly polarized to provide an alignment regulating force.

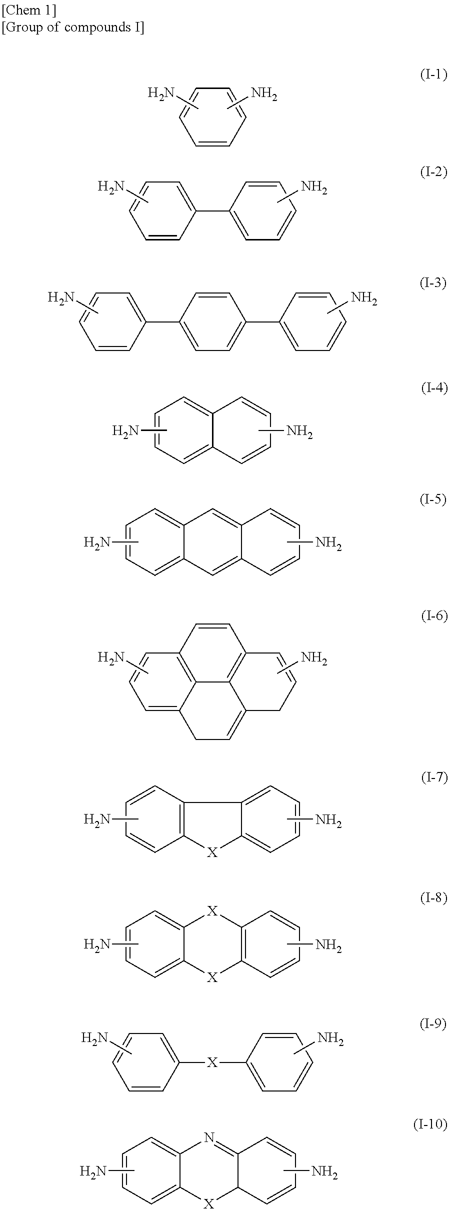

where X's each independently represent any one of the following structures: —CH₂—, —CO—, —O—, —NH—, —CO—NH—, —S—, —SO—, and —SO₂—.

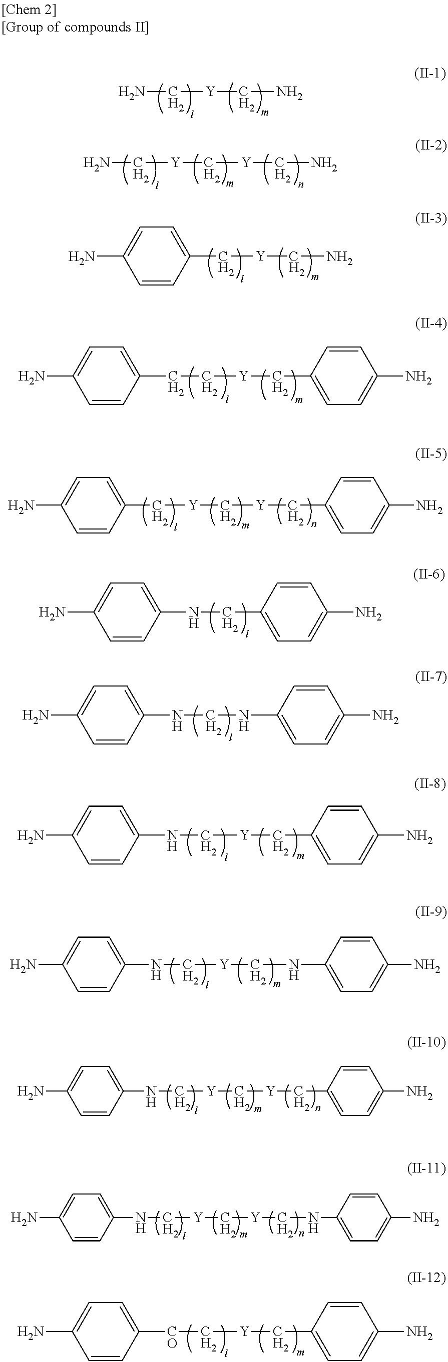

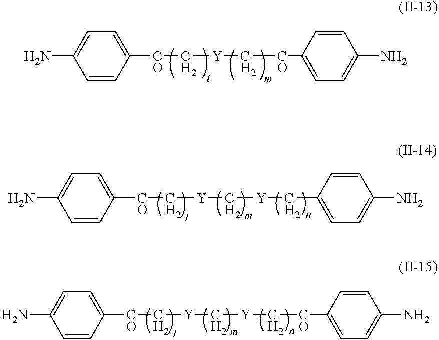

where: l's, m's, and n's each independently represent an integer of 0 to 6; and Y's each represent any one of the following structures: —NH—, —CH═CH—, —CH═CH—, —O—CH═CH—O—, —C≡C—, —O—C≡C—, —O—C≡C—O—, —CH═CH—COO—, and —OOC—CH═CH—COO—.

A liquid crystal display device includes: a pair of substrates, at least one of which is transparent; a liquid crystal layer arranged between the pair of substrates; an electrode group formed on at least one of the pair of substrates, for applying an electric field to the liquid crystal layer; and an alignment control film arranged on at least one of the pair of substrates, in which the alignment control film is made of a polyimide and a polyimide precursor, and the polyimide and the polyimide precursor include, as raw materials, at least one kind of diamine selected from a group of compounds I represented by the following chemical formulae (I-1) to (I-10), at least one kind of compound selected from a group of compounds

III represented by the following chemical formulae (III-1) to (III-6), and a cyclobutanetetracarboxylic dianhydride as an acid anhydride, and are irradiated with light that has been substantially linearly polarized to provide an alignment regulating force.

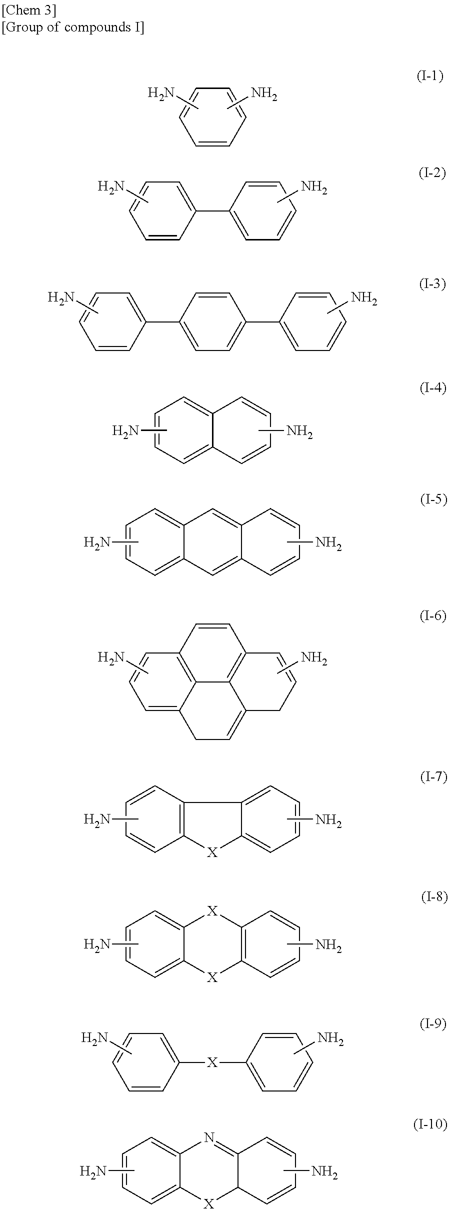

where X's each independently represent any one of the following structures: —CH₂—, —CO—, —O—, —NH—, —CO—NH—, —S—, —SO—, and —SO₂—.

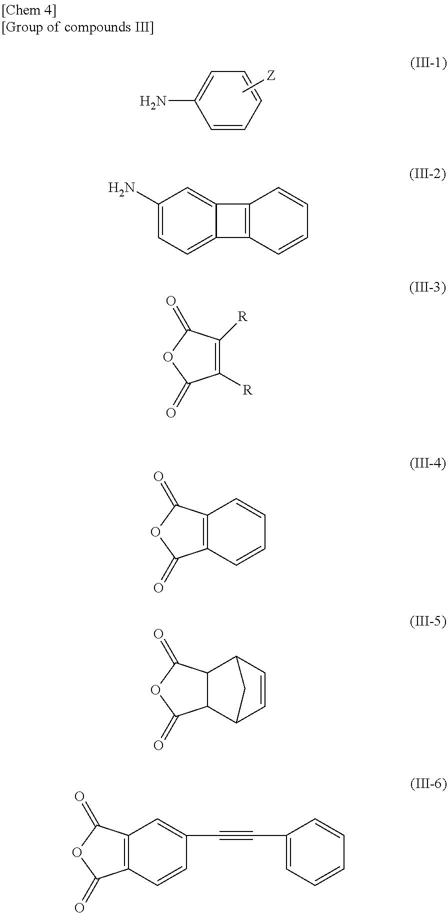

where: R's each independently represent one of a hydrogen atom, a methyl group, and a phenyl group; and Z represents any one of the following structures: a vinyl group, an alkynyl group, H₂C═CH—COO—(CH₂)ₙ— where n represents one of 0, 1, and 2, N≡C—O—, and F₂C═CFO—.

According to the present invention, the residual image in the liquid crystal display device can be reduced.

### BRIEF DESCRIPTION OF THE DRAWINGS

In the accompanying drawings:

FIG. 1 is a cross-sectional view of a pixel portion illustrating a pixel configuration according to Example 1;

FIG. 2A is a plan view of the pixel portion illustrating the pixel configuration according to Example 1;

FIG. 2B is a cross-sectional view of the pixel portion illustrating the pixel configuration according to Example 1, which corresponds to a partial cross-sectional view taken along the line 2B-2B of FIG. 2A;

FIG. 2C is a cross-sectional view of the pixel portion illustrating the pixel configuration according to Example 1, which corresponds to a partial cross-sectional view taken along the line 2C-2C of FIG. 2A;

FIG. 3 is a cross-sectional view of a pixel portion illustrating a pixel configuration according to Example 2;

FIG. 4A is a plan view of the pixel portion illustrating the pixel configuration according to Example 2;

FIG. 4B is a cross-sectional view of the pixel portion illustrating the pixel configuration according to Example 2, which corresponds to a partial cross-sectional view taken along the line 4B-4B of FIG. 4A;

FIG. 4C is a cross-sectional view of the pixel portion illustrating the pixel configuration according to Example 2, which corresponds to a partial cross-sectional view taken along the line 4C-4C of FIG. 4A;

FIG. 5 is a cross-sectional view of a pixel portion illustrating a pixel configuration according to Example 3;

FIG. 6 is a cross-sectional view of a pixel portion illustrating a pixel configuration according to Example 4;

FIG. 7 is a cross-sectional view of a pixel portion illustrating a pixel configuration according to Examples 5 to 8; and

FIG. 8 is a plan view of the pixel portion illustrating the pixel configuration according to Examples 5 to 8.

### DETAILED DESCRIPTION OF THE INVENTION

As a rubbingless alignment method for solving the problems inherent in the rubbing alignment method, a photo-alignment method using light irradiation has been proposed and studied. However, the photo-alignment method suffers from the following practical problems.

In a polymer material system in which a photoreactive group is introduced into polymer side chains typified by polyvinyl cinnamate, the thermal stability of alignment is not sufficient, and sufficient reliability is not yet obtained from the practical viewpoint.

Further, in this case, it is conceivable that the structural site that develops the alignment of liquid crystal is a polymer side chain portion. Therefore, the above-mentioned alignment method is not always preferred in more uniformly aligning liquid crystal molecules and obtaining stronger alignment. Further, when a low-molecular dichroic dye is dispersed in a polymer, the dye per se that aligns the liquid crystal has a low molecular weight, and there remains a practical problem in view of the thermal or optical reliability.

A photo-alignment method using photolysis of cyclobutane-based polyimide is an effective method high in the stability of alignment. However, in recent years, there is an increasing need for the stability of alignment, and the conventional cyclobutane-based polyimide material cannot satisfy this need.

The present invention has been made to solve such a problem that manufacturing margin of an aligning process is narrow, and therefore an object of the present invention is to provide a liquid crystal display device that reduces the occurrence of a display defect caused by a variation in initial alignment direction, and realizes a stable liquid crystal alignment to provide a high image quality which is high in contrast ratio.

According to one aspect of the present invention, there is provided a liquid crystal display device including: a pair of substrates, at least one of which is transparent; a liquid crystal layer arranged between the pair of substrates; an electrode group formed on at least one of the pair of substrates, for applying an electric field to the liquid crystal layer; and an alignment control film arranged on at least one of the pair of substrates, in which the alignment control film is made of a polyimide and a polyimide precursor, and the polyimide and the polyimide precursor have an aromatic ring and a cross-linking moiety in the main chain in chemical structure, have no side chain component having 2 or more carbon atoms in the aromatic ring, contain a cyclobutanetetracarboxylic dianhydride as a raw material, and are irradiated with light that has been substantially linearly polarized to provide an alignment regulating force.

The polyimide and the polyimide precursor have an aromatic ring and a cross-linking moiety in the main chain in chemical structure, and have no side chain component having 2 or more carbon atoms in the aromatic ring. The polyimide and the polyimide precursor contain a cyclobutanetetracarboxylic dianhydride as a raw material. The polyimide and the polyimide precursor are irradiated with light that has been substantially linearly polarized to provide the alignment regulating force, thereby forming an alignment control film that reduces a residual image in the liquid crystal display device.

According to another aspect of the present invention, there is provided a liquid crystal display device including: a pair of substrates, at least one of which is transparent; a liquid crystal layer arranged between the pair of substrates; an electrode group formed on at least one of the pair of substrates, for applying an electric field to the liquid crystal layer; and an alignment control film arranged on at least one of the pair of substrates, in which the alignment control film is made of a polyimide and a polyimide precursor, and the polyimide and the polyimide precursor include, as raw materials, at least one kind of diamine selected from a group of compounds I represented by the following chemical formulae (I-1) to (I-10), at least one kind of diamine selected from a group of compounds II represented by the following chemical formulae (II-1) to (II-15), and a cyclobutanetetracarboxylic dianhydride as an acid anhydride, and are irradiated with light that has been substantially linearly polarized to provide an alignment regulating force.

The polyimide and the polyimide precursor include, as raw materials, at least one kind of diamine selected from the group of compounds I represented by the following chemical formulae (I-1) to (I-10), at least one kind of diamine selected from the group of compounds II represented by the following chemical formulae (II-1) to (II-15), and a cyclobutanetetracarboxylic dianhydride as an acid anhydride, and are irradiated with light that has been substantially linearly polarized to provide an alignment regulating force, thereby forming an alignment control film that reduces a residual image in the liquid crystal display device.

The alignment control film according to the present invention includes polyimide and a polyimide precursor, and an aromatic diamine forming the polyimide and the polyimide precursor has no side chain component having 2 or more carbon atoms.

According to another aspect of the present invention, there is provided a liquid crystal display device including: a pair of substrates, at least one of which is transparent; a liquid crystal layer arranged between the pair of substrates; an electrode group formed on at least one of the pair of substrates, for applying an electric field to the liquid crystal layer; and an alignment control film arranged on at least one of the pair of substrates, in which the alignment control film is made of a polyimide and a polyimide precursor, and the polyimide and the polyimide precursor include, as raw materials, at least one kind of diamine selected from a group of compounds I represented by the following chemical formulae (I-1) to (I-10), at least one kind of compound selected from a group of compounds III represented by the following chemical formulae (III-1) to (III-6), and a cyclobutanetetracarboxylic dianhydride as an acid anhydride, and are irradiated with light that has been substantially linearly polarized to provide an alignment regulating force.

The polyimide and the polyimide precursor include, as raw materials, at least one kind of diamine selected from the group of compounds I represented by the following chemical formulae (I-1) to (I-10), at least one kind of compound selected from the group of compounds III represented by the following chemical formulae (III-1) to (III-6), and a cyclobutanetetracarboxylic dianhydride as an acid anhydride, and are irradiated with light that has been substantially linearly polarized to provide an alignment regulating force, thereby forming an alignment control film that reduces a residual image in the liquid crystal display device.

For example, in a liquid crystal display device including: a pair of substrates, at least one of which is transparent; a liquid crystal layer arranged between the pair of substrates; an electrode group formed on at least one of the pair of substrates, for applying an electric field to the liquid crystal layer; and an alignment control film arranged on at least one of the pair of substrates, in which the alignment control film is made of a polyimide and a polyimide precursor, and the polyimide and the polyimide precursor include, as raw materials, at least one kind of diamine selected from the group of compounds I represented by the following chemical formulae (I-1) to (I-10), at least one kind of diamine selected from the group of compounds II represented by the following chemical formulae (II-1) to (II-15), and a cyclobutanetetracarboxylic dianhydride as an acid anhydride, and are irradiated with light that has been substantially linearly polarized to provide an alignment regulating force, it is preferred that the polyimide and the polyimide precursor further include, as a raw material, at least one kind of compound selected from a group of compounds III represented by the following chemical formulae (III-1) to (III-6).

That is, it is preferred that the polyimide and the polyimide precursor include, as raw materials, at least one kind of diamine selected from the group of compounds I represented by the following chemical formulae (I-1) to (I-10), at least one kind of diamine selected from the group of compounds II represented by the following chemical formulae (II-1) to (II-15), at least one kind of compound selected from the group of compounds III represented by the following chemical formulae (III-1) to (III-6), and a cyclobutanetetracarboxylic dianhydride as the acid anhydride, and be irradiated with light that has been substantially linearly polarized to provide an alignment regulating force.

The polyimide and the polyimide precursor further include, as a raw material, at least one kind of compound selected from the group of compounds III represented by the following chemical formulae (III-1) to (III-6), thereby forming an alignment control film that reduces a residual image in the liquid crystal display device.

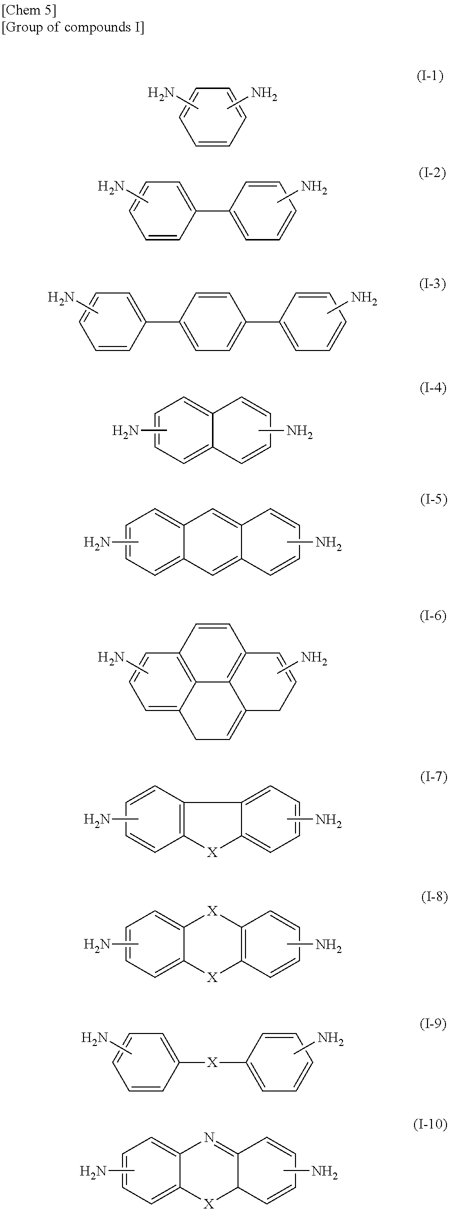

where X's each independently represent any one of the following structures: —CH₂—, —CO—, —O—, —NH—, —CO—NH—, —S—, —SO—, and —SO₂—.

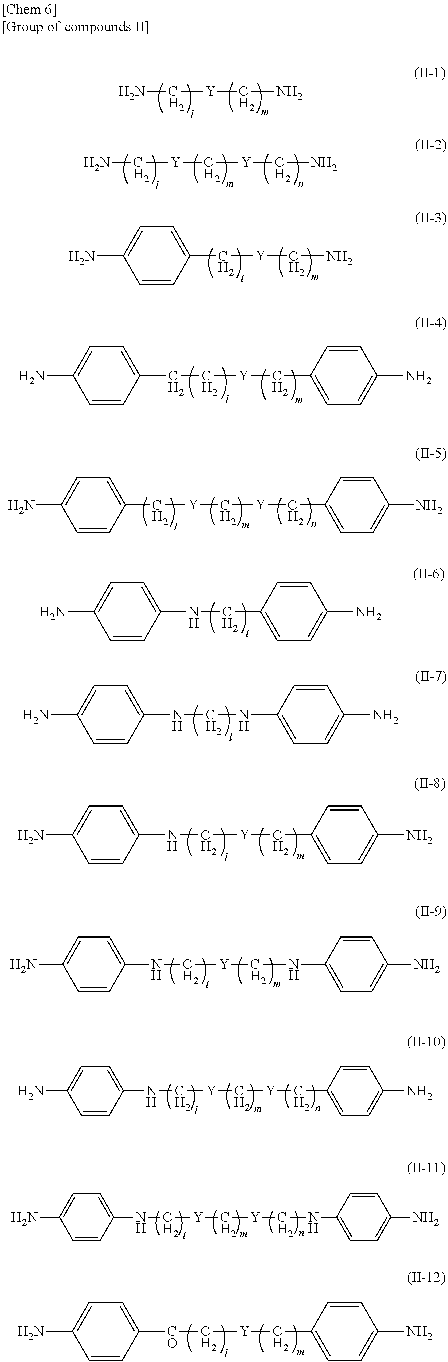

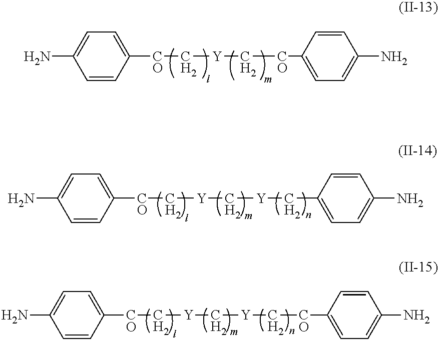

where: l's, m's, and n's each independently represent an integer of 0 to 6; and Y's each represent any one of the following structures: —NH—, —CH═CH—, —O—CH═CH—, —O—CH═CH—O—, —C═C—, —O—C≡C—, —O—C≡C—O—, —CH═CH—COO—, and —OOC—CH═CH—COO—.

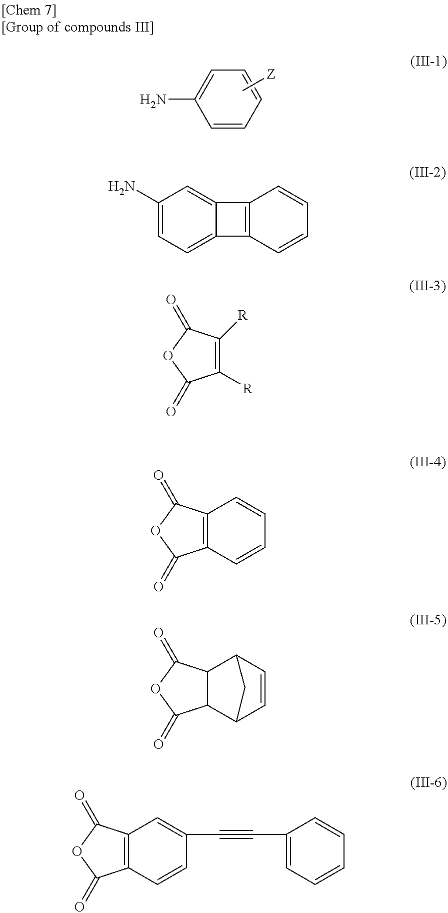

where: R's each independently represent one of a hydrogen atom, a methyl group, and a phenyl group; and Z represents any one of the following structures: a vinyl group, an alkynyl group, H₂C═CH—COO—(CH₂)ₙ— where n represents one of 0, 1, and 2, N≡C—O—, and F₂C═CFO—.

A group of compounds A represented by the chemical formulae (A-1) to (A-67), a group of compounds B represented by the chemical formulae (B-1) to (B-34), and a group of compounds C represented by the chemical formulae (C-1) to (C-16) are given below as specific structural examples of the group of compounds I, the group of compounds II, and the group of compounds III, respectively, each of which serves as a raw material for the polyimide and the polyimide precursor forming the alignment control film according to the present invention. Each of those structures is merely an example of specific chemical structures, and the present invention is not limited to those structures.

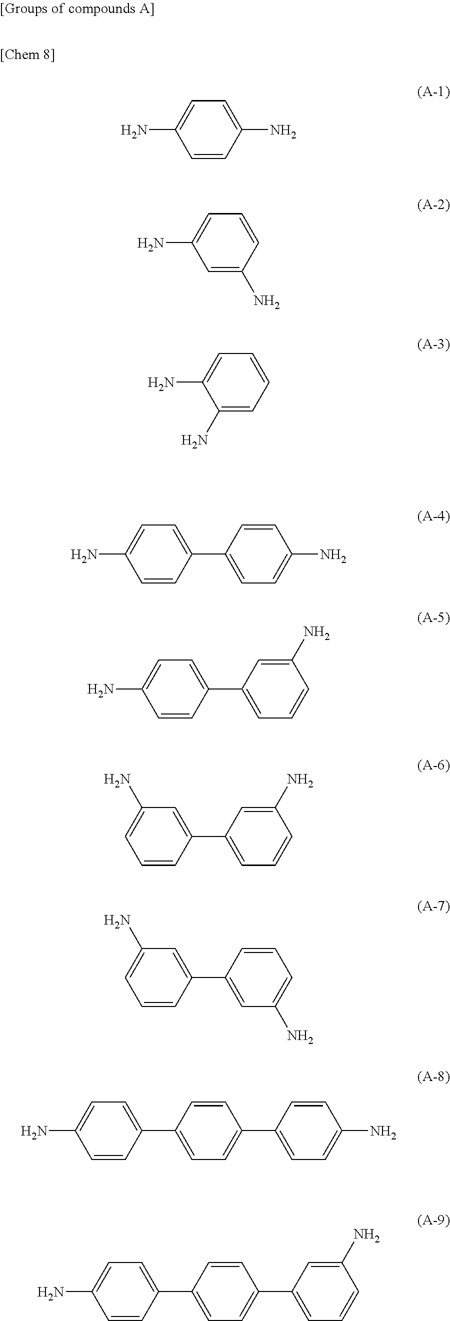

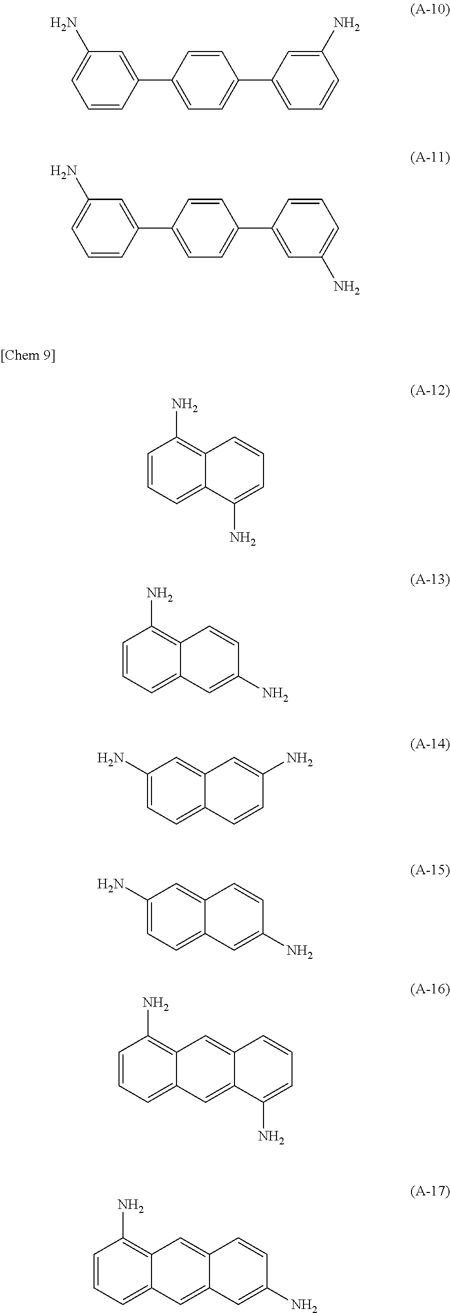

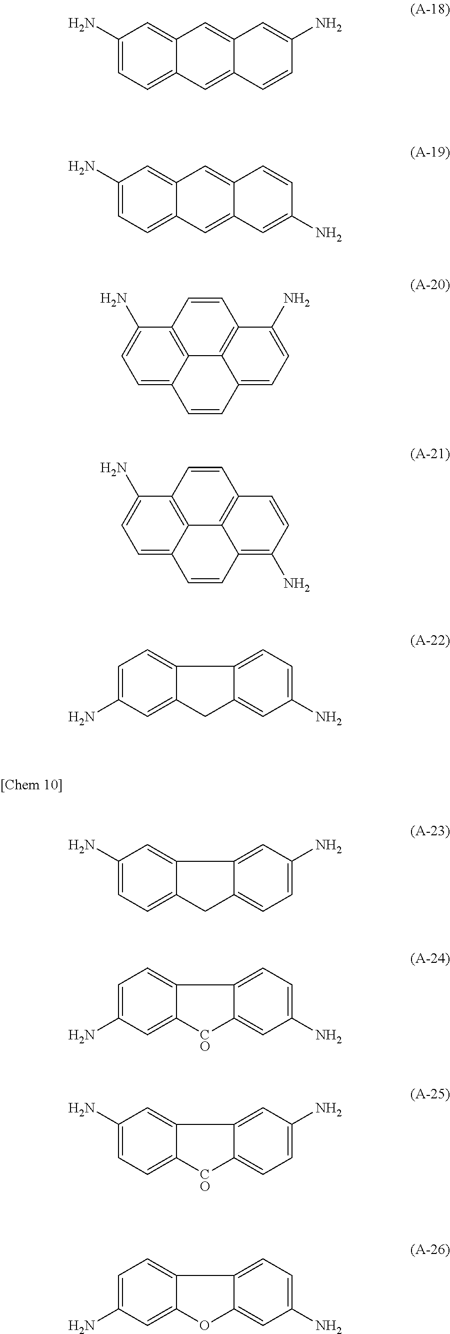

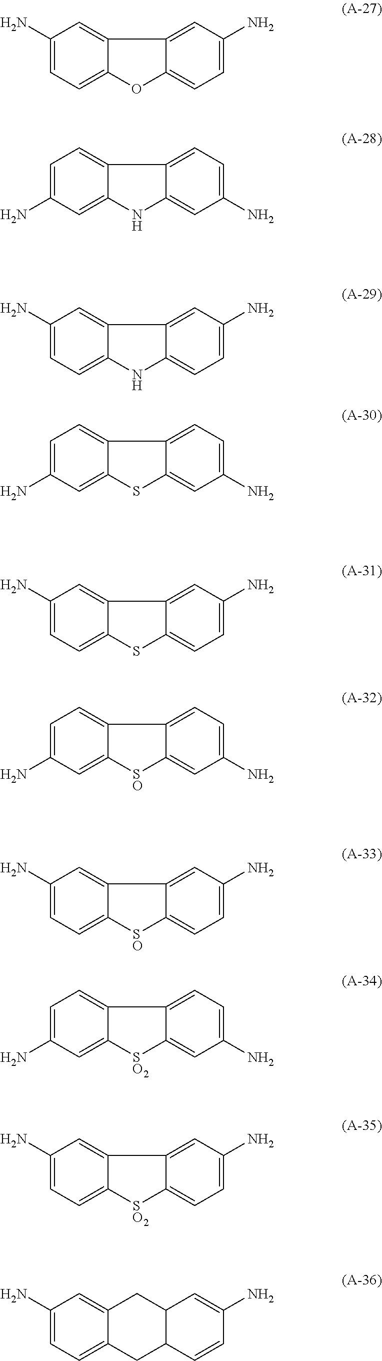

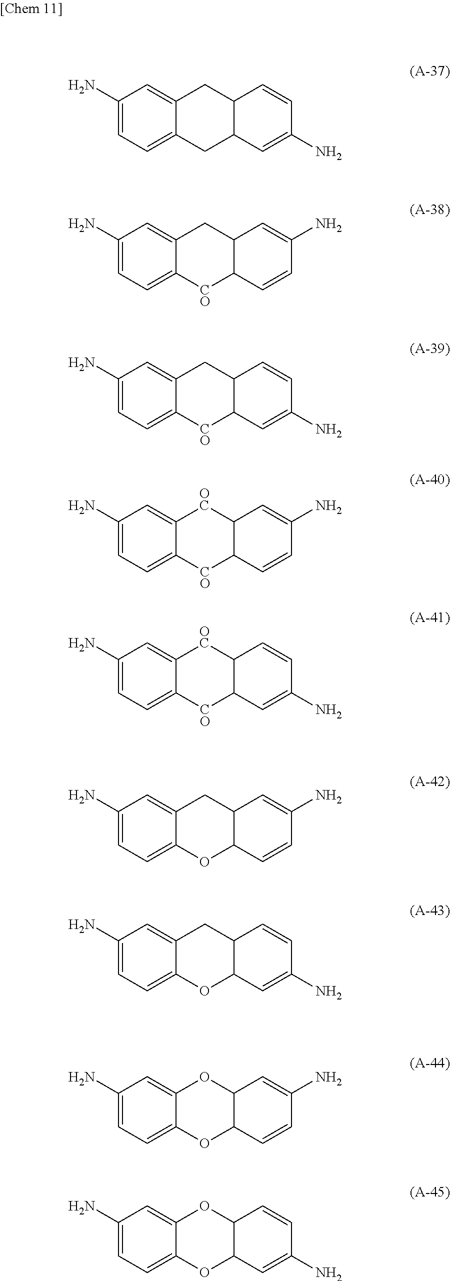

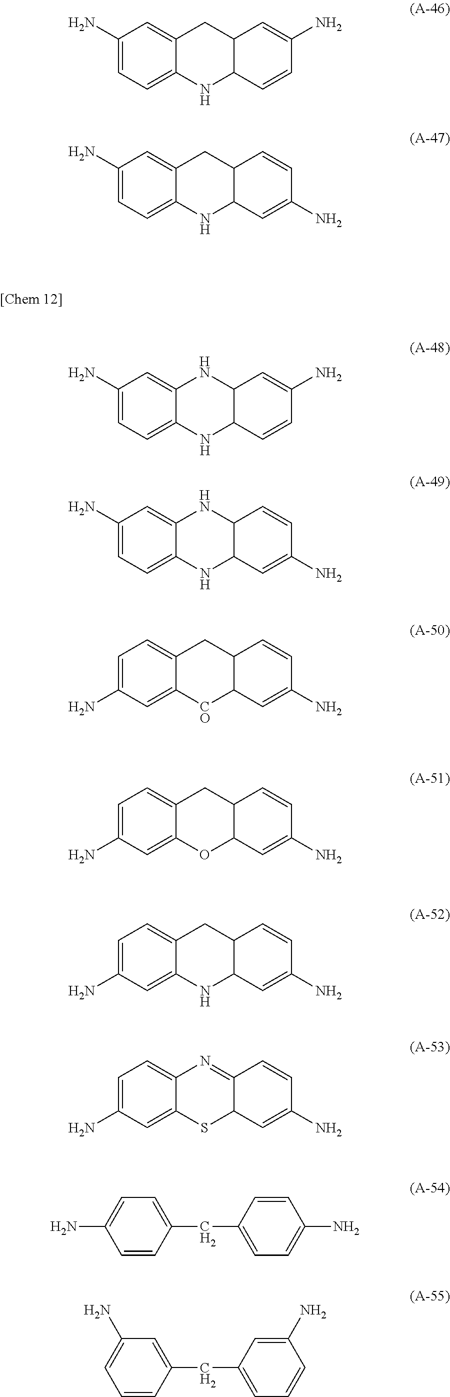

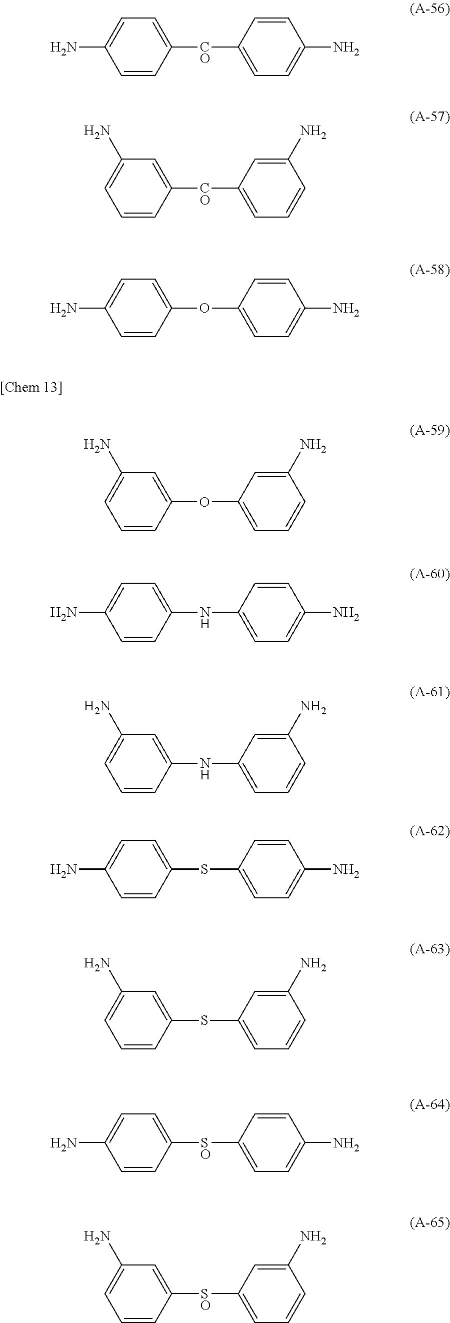

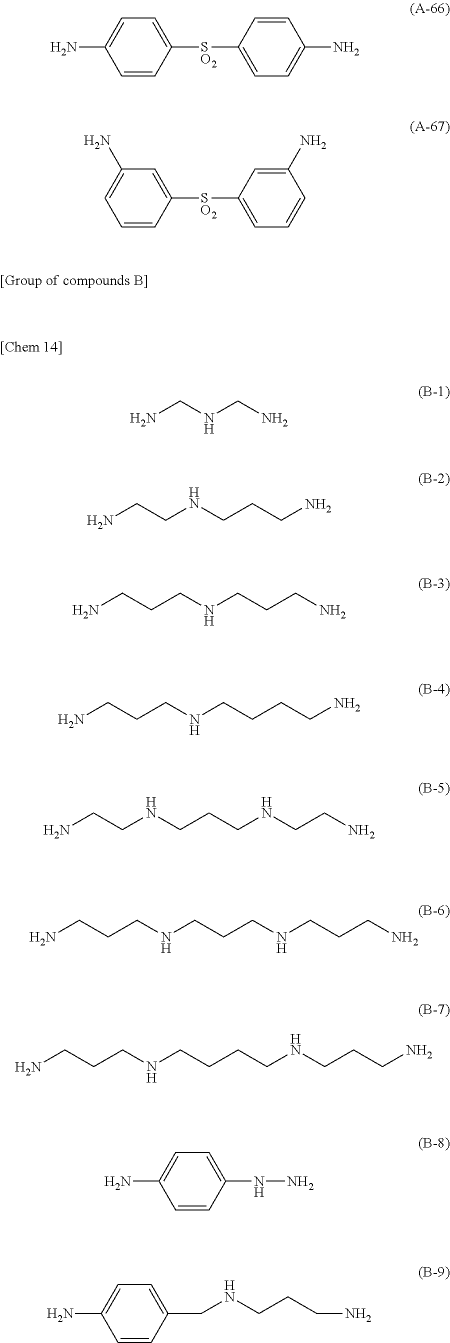

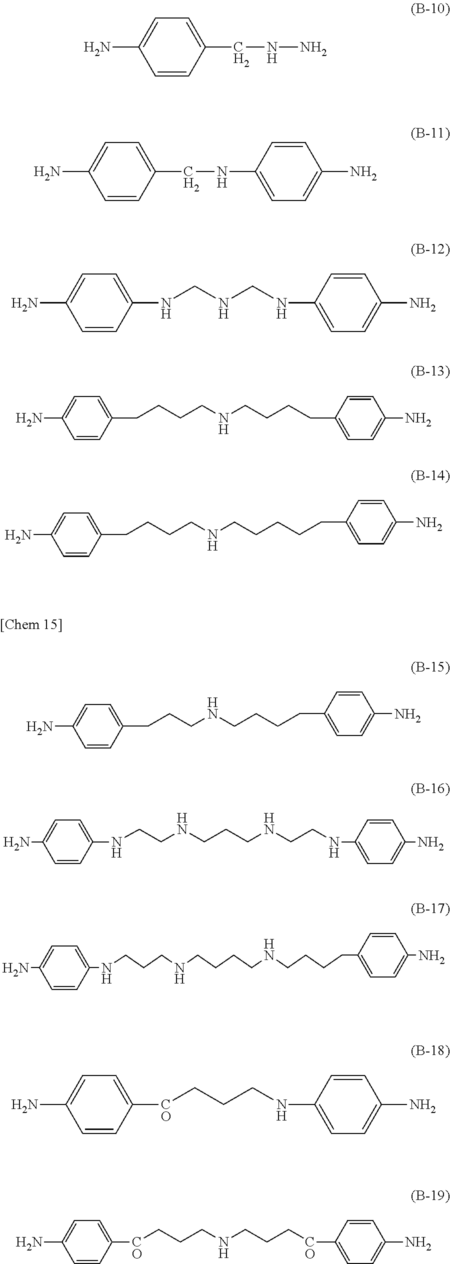

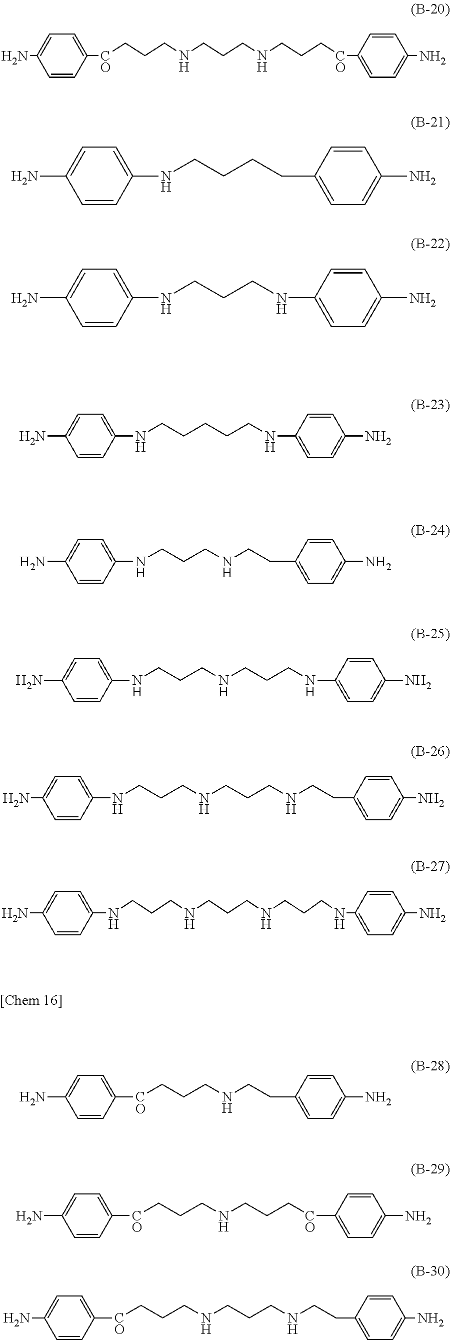

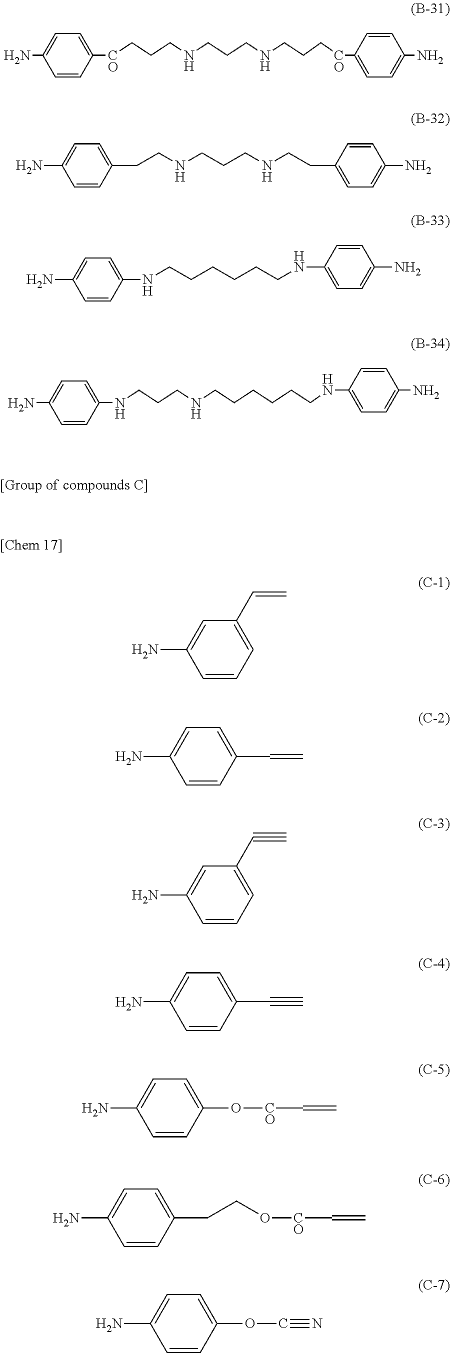

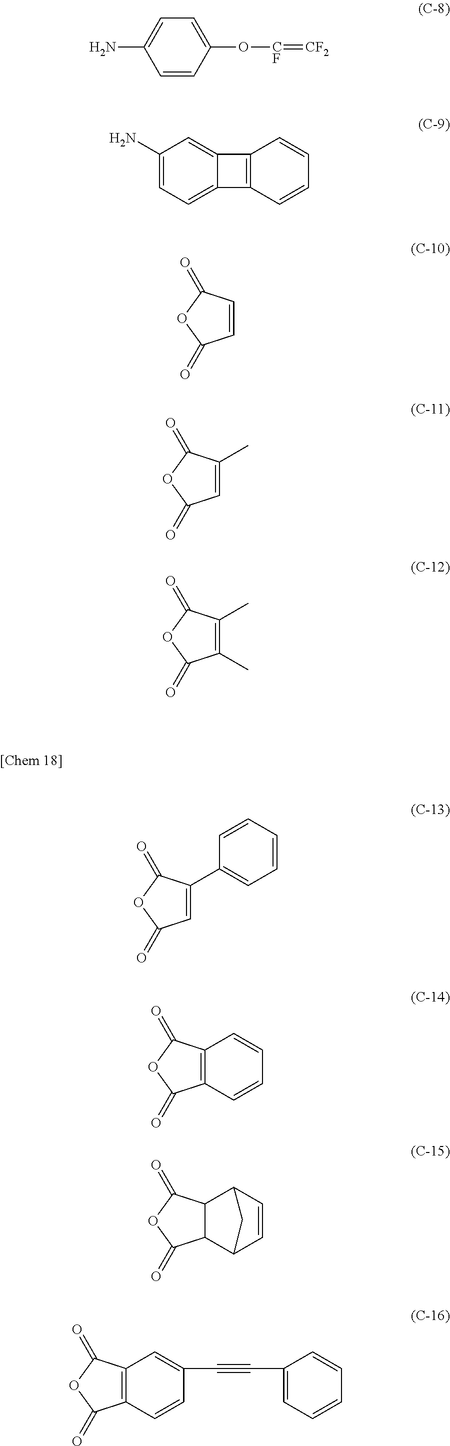

Among the above-mentioned group of compounds A, the alignment control film made of the raw material of (A-1), (A-4), (A-8), (A-19), (A-21), (A-22), (A-28), (A-29), (A-30), (A-32), (A-47), or (A-53) is particularly preferred because of the excellent liquid crystal alignment property.

The polyimide precursor that forms the alignment control film provided in the liquid crystal display device according to the present invention may be a polyamide acid and a polyamide acid alkyl ester. Further, the polyimide precursor may be a polyamide acid alkyl ester having 1 to 3 carbon atoms.

Further, the polyimide precursor may be a polyamide acid alkyl ester having 1 or 2 carbon atoms.

Further, the polyimide precursor may be a polyamide acid alkyl ester having 2 or 3 carbon atoms.

Further, the polyimide precursor may be a polyamide acid methyl ester.

Further, the polyimide precursor may be a polyamide acid ethyl ester.

Further, the polyimide precursor maybe a polyamide acid propyl ester.

The polyamide acid is obtained by stirring and polymerizing a diamine and a tetracarboxylic dianhydride in an organic solvent.

More specifically, a diamine is dissolved in a polar amide solvent such as N-methyl pyrrolidone (NMP). The tetracarboxylic dianhydride having substantially the same moles as those of the diamine is added to the solution, and stirred at room temperature. Then, a ring-opening addition polymerization reaction is advanced between the tetracarboxylic dianhydride and the diamine in accordance with the dissolution of the tetracarboxylic dianhydride to obtain a polyamide acid having a high molecular weight.

Further, in the case of the polyamide acid ester, a chlorinating reagent such as thionyl chloride is allowed to react with a diester dicarboxylic acid obtained by allowing an alcohol to react with a tetracarboxylic dianhydride, to thereby obtain a high-reactive diester dicarboxylic chloride. The diester dicarboxylic chloride is allowed to react with the diamine for polycondensation to obtain a polyamide acid alkyl ester.

In this situation, a plurality of kinds of diamines and tetracarboxylic dianhydrides as raw materials are mixed together, thereby obtaining a copolymer in which a plurality of chemical species are polymerized in one polymer chain.

Each of the compounds represented by the group of compounds III has only one polycondensable reactive site. When such compound is added as a raw material, the compound becomes a terminal component of the polymer chain.

When a plurality of kinds of aromatic diamines shown in the group of compounds I are mixed together, the absorption wavelength range of the generated polyimide is widened. Therefore, the spectrum of a light source for emission can be effectively utilized.

Further, when a plurality of kinds of cross-linking diamines shown in the group of compounds II or cross-linking amines shown in the group of compounds III are mixed together, a possibility that various functional groups generated in a photoreaction can be cross-linked becomes high. Therefore, it is more desirable to mix the plurality of kinds of cross-linking diamines or amines together.

Further, in a liquid crystal display device including: a pair of substrates, at least one of which is transparent; a liquid crystal layer arranged between the pair of substrates; an electrode group formed on at least one of the pair of substrates, for applying an electric field to the liquid crystal layer; and an alignment control film arranged on at least one of the pair of substrates, in which the alignment control film is made of a polyimide and a polyimide precursor, and the polyimide and the polyimide precursor include, as raw materials, at least one kind of diamine selected from the group of compounds I represented by the chemical formulae (I-1) to (I-10), at least one kind of diamine selected from the group of compounds II represented by chemical formulae (II-1) to (II-15), and a cyclobutanetetracarboxylic dianhydride as an acid anhydride, and are irradiated with light that has been substantially linearly polarized to provide an alignment regulating force, the polyimide and the polyimide precursor may include, as raw materials, at least two different kinds of diamines shown in the group of compounds I.

Further, the polyimide and the polyimide precursor may include, as raw materials, at least three different kinds of diamines shown in the group of compounds I.

Further, the polyimide and the polyimide precursor may include, as raw materials, at least two different kinds of diamines shown in the group of compounds II.

Further, the polyimide and the polyimide precursor may include, as raw materials, at least three different kinds of diamines shown in the group of compounds II.

Further, in a liquid crystal display device including: a pair of substrates, at least one of which is transparent; a liquid crystal layer arranged between the pair of substrates; an electrode group formed on at least one of the pair of substrates, for applying an electric field to the liquid crystal layer; and an alignment control film arranged on at least one of the pair of substrates, in which the alignment control film is made of a polyimide and a polyimide precursor, and the polyimide and the polyimide precursor include, as raw materials, at least one kind of diamine selected from the group of compounds I represented by the chemical formulae (I-1) to (I-10), at least one kind of compound selected from the group of compounds III represented by the chemical formulae (III-1) to (III-6), and a cyclobutanetetracarboxylic dianhydride as an acid anhydride, and are irradiated with light that has been substantially linearly polarized to provide an alignment regulating force, the polyimide and the polyimide precursor may include, as raw materials, at least two different kinds of diamines shown in the group of compounds I.

Further, the polyimide and the polyimide precursor may include, as raw materials, at least three different kinds of diamines shown in the group of compounds I.

Further, the polyimide and the polyimide precursor may include, as raw materials, at least two different kinds of compounds shown in the group of compounds III.

Further, the polyimide and the polyimide precursor may include, as raw materials, at least three different kinds of compounds shown in the group of compounds III.

Further, in a liquid crystal display device including: a pair of substrates, at least one of which is transparent; a liquid crystal layer arranged between the pair of substrates; an electrode group formed on at least one of the pair of substrates, for applying an electric field to the liquid crystal layer; and an alignment control film arranged on at least one of the pair of substrates, in which the alignment control film is made of a polyimide and a polyimide precursor, and the polyimide and the polyimide precursor include, as raw materials, at least one kind of diamine shown in the group of compounds I, at least one kind of diamine shown in the group of compounds II, and a cyclobutanetetracarboxylic dianhydride as an acid anhydride, and are irradiated with light that has been substantially linearly polarized to provide an alignment regulating force, the polyimide and the polyimide precursor may further include, as raw materials, at least two different kinds of compounds shown in the group of compounds III.

Further, the polyimide and the polyimide precursor may further include, as raw materials, at least three different kinds of compounds shown in the group of compounds III.

As described above, the diamine and the tetracarboxylic dianhydride are polymerized to obtain a polyimide precursor having a high molecular weight.

In the present invention, it is assumed that amine compounds include an amino group in the chemical structure. For example, monoamines represented by the chemical formulae (III-1) and (III-2) in the group of compounds III, and diamines shown in the groups of compounds I and II correspond to such amine compounds.

Further, in the present invention, it is assumed that the acid anhydride represents a carboxylic acid anhydride. For example, acid anhydrides represented by the chemical formulae (III-3) to (III-6) and cyclobutanetetracarboxylic dianhydride correspond to such carboxylic anhydride.

Polyimide and the polyimide precursor are formed using the amine compound and the acid anhydride as raw materials. It is preferred that the amine compound and the acid anhydride react with each other at from about 1:0.95 to 1:1.05 (blending molar ratio) to 0.95:1 to 1.05:1 (blending molar ratio) to form polyimide and the polyimide precursor having a high molecular weight suitable for the liquid crystal alignment film of the present invention.

That is, it is preferred that the ratio amine compound/acid anhydride (blending molar ratio) range from 0.95 to 1.05.

Further, it is more preferred that the amine compound and the acid anhydride react with each other at 1:1 (blending molar ratio).

Further, the amine compound used as the raw material forming the polyimide and the polyimide precursor may be made from only a diamine. When the amine compound is made from only a diamine, it is assumed that the amine compound particularly represents a diamine compound in the present invention.

Further, the acid anhydride used as the raw material forming the polyimide and the polyimide precursor may be made from only cyclobutanetetracarboxylic dianhydride.

As a preferred example, the diamine compound used as the raw material forming the polyimide and the polyimide precursor contains one or more diamines selected from the group of compounds I at a ratio of from 50 mol % or more to 95 mol % or less.

That is, the polyimide and the polyimide precursor which include, as raw materials, the diamine compound containing one or more diamines selected from the group of compounds I at a ratio of from 50 mol % or more to 95 mol % or less, and a tetracarboxylic dianhydride can be preferably used for the alignment control film.

As another preferred example, the diamine compound used as the raw material forming the polyimide and the polyimide precursor contains one or more diamines selected from the group of compounds II at a ratio of from 5 mol % or more to 50 mol % or less.

That is, polyimide and the polyimide precursor which include, as raw materials, the diamine compound containing one or more diamines selected from the group of compounds II at a ratio of from 5 mol % or more to 50 mol % or less, and a tetracarboxylic dianhydride can be preferably used for the alignment control film.

As another preferred example, the polyimide and the polyimide precursor include, as a raw material, one or more compounds selected from the group of compounds III shown in the chemical formulae (III-1) to (III-6) at a ratio of from 1 molt or more to 2.5 mol % or less.

That is, as the preferred examples, the amine compound used as the raw material forming the polyimide and the polyimide precursor contains one or more amines selected from the group of compounds represented by the chemical formulae (III-1) and (III-2) at a ratio of from 2 mol % or more to 5 mol % or less. The acid anhydride used as the raw material forming the polyimide and the polyimide precursor contains one or more dicarboxylic anhydrides selected from the group of compounds represented by the chemical formulae (III-3) to (III-6) at a ratio of from 2 mol % or more to 5 mol % or less. The polyimide and the polyimide precursor include, as raw materials, one or more amines selected from the group of compounds represented by the chemical formulae (III-1) and (III-2) and one or more dicarboxylic anhydrides selected from the group of compounds represented by the chemical formulae (III-3) to (III-6) at a total molar ratio of from 1 mol % or more to 2.5 mol % or less.

As another preferred example, the tetracarboxylic dianhydride used as the raw material forming the polyimide and the polyimide precursor contain cyclobutanetetracarboxylic dianhydride at a ratio of from 70 mol % or more to 100 mol % or less.

That is, the polyimide and the polyimide precursor which include, as raw materials, a tetracarboxylic dianhydride containing cyclobutanetetracarboxylic dianhydride at a ratio of from 70 mol % or more to 100 mol % or less, and a diamine can be preferably used for the alignment control film.

The polyimide forming the alignment control film of the present invention is obtained by advancing imidization of a polyamide acid or a polyamide acid ester as the polyimide precursor by heating or chemical imidization.

In this situation, it is not always necessary to progress the imidization by 100%, and the imidization is advanced preferably by 50% to 100% of the total, more preferably by 60% to 95%, and still more preferably by 70% to 90%.

As the degree of progress of the imidization is higher, the light alignment property is higher, and the alignment stability of liquid crystal is higher. However, when the degree of progress of the imidization is too high, a specific resistance of the alignment film becomes high, which is not preferred in the electric characteristics.

Further, it is desirable that the molecular weight of the polyimide forming the alignment control film be higher. The polyamide acid ester does not undergo any decrease in molecular weight during heating unlike the polyamide acid. Therefore, the polyamide acid ester is high in the alignment stability of liquid crystal, which is more preferred.

When a cyclobutane-based polyimide made from the above-mentioned raw materials is irradiated with light, a photolytic reaction involving the cleavage of the ring structure of cyclobutane to generate a maleimide terminal occurs. When the photolytic reaction progresses, the cyclobutane-based polyimide which had initially a high molecular weight undergoes a decrease in molecular weight to provide a film having a lower strength.

The inventors of the present invention found that the alignment stability of liquid crystal was deteriorated with a reduction in the film strength. In order to improve the alignment stability of liquid crystal, an improvement in the strength of the film is essential. In order to improve the film strength, the maleimide terminal generated by photolysis needs to be stabilized by the cross-linking reaction.

However, the conventional cyclobutane-based polyimide suffers from such a problem that the film strength is insufficient. Because higher quality of liquid crystal display devices is now being encouraged, the conventional alignment stability is not allowable as a product.

The above-mentioned alignment control film according to the present invention contains, for example, a cross-linking moiety represented by the structure of Y in the general formulae of the group of compounds II, and a cross-linking group represented by the group of compounds III in the main chain.

The alignment control film according to the present invention is excellent in the alignment stability because the cross-linking moieties sufficiently exist, and the cross-linking reaction of a maleimide sufficiently progresses.

The polyimide and the polyimide precursor forming the alignment control film according to the present invention have the cross-linking moiety in the main chain. Because side chain components of a polymer inhibit packing of the main chains to reduce the film strength, it is preferred that the cross-linking moieties be disposed in the main chains.

Further, preferably, the side chain components are shorter as much as possible, and more preferably, no side chain components exist.

Specifically, the hardness of the alignment control film ranges preferably from 0.1 GPa or more to 1.0 GPa or less, more preferably from 0.2 GPa or more to 0.9 GPa or less, and still more preferably from 0.3 GPa or more to 0.8 GPa or less.

When the hardness of the alignment control film is too high, there arises such a trouble that the alignment control film is liable to be peeled off due to the vibrations of the liquid crystal panel, which is not preferred.

The measurement of the hardness of the alignment control film was implemented by continuous stiffness measurement (CSM) with the use of a Berkovich indenter of a nano indenter G200 made by MTS Systems Corporation. The CSM use frequency was 75 Hz, and the amplitude value was 1 nm. The measurement points were 10 points, the indentation depth at the respective measurement points was 50 nm at maximum, and the hardness was calculated by using values of from 18 nm to 20 nm.

This nano indenter measurement conforms to ISO-14577 Parts 1, 2 and 3.

It is preferred that the cyclobutanetetracarboxylic dianhydride which is the raw material for the polyimide, or a polyamide acid or a polyamide acid ester as the polyimide precursor forming the alignment control film of the present invention be a compound represented by the following chemical formula (IV-1).

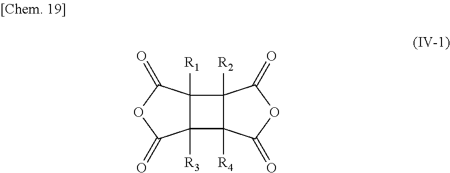

where: R₁ to R₄ each independently represent one of a hydrogen atom, an alkyl group having 1 to 3 carbon atoms, and the following structure: —(CH₂)ₙ—COOH where n represents one of 0 and 1.

It is preferred that R₁ to R₄ each independently represent one of a hydrogen atom, an alkyl group having 1 or 2 carbon atoms, and the following structure: —(CH₂)ₙ—COOH where n represents one of 0 and 1.

It is more preferred that R₁ to R₄ each independently represent one of a hydrogen atom, a methyl group, and a carboxyl group.

It is still more preferred that R₁ to R₄ each independently represent one of a hydrogen atom and a methyl group.

It is particularly preferred that R₁ to R₄ each represent a methyl group.

Specific structural examples of the cyclobutanetetracarboxylic dianhydride according to the present invention are represented by the following chemical formulae (D-1) to (D-8). Each of those structures is merely an example of specific chemical structures, and the present invention is not limited to those structures.

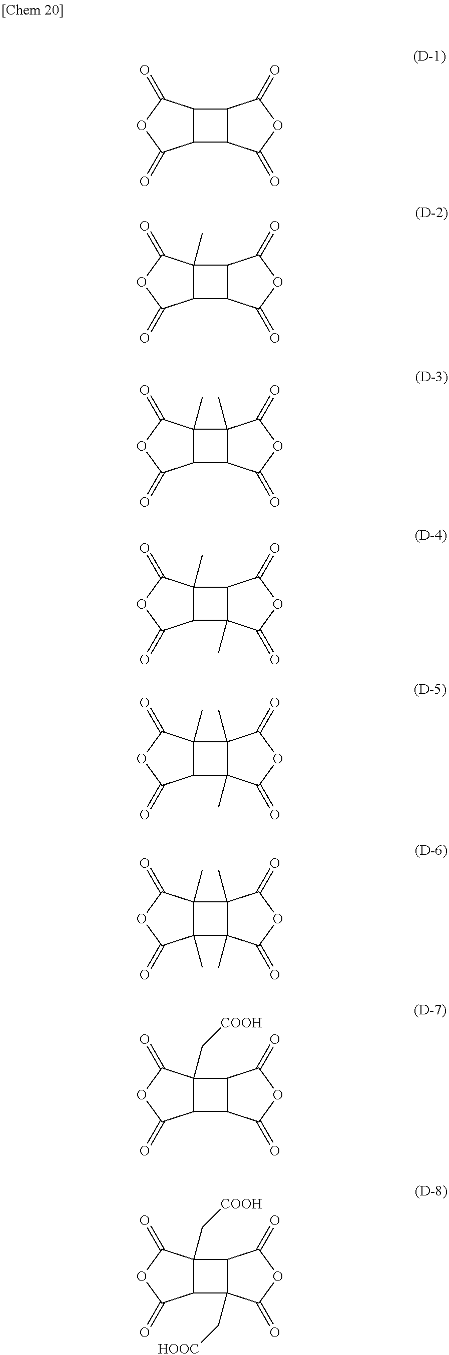

It is further preferred that the tetracarboxylic dianhydride used as the raw material forming the polyimide and the polyimide precursor according to the present invention include at least one kind of cyclobutanetetracarboxylic dianhydride represented by the chemical formula (IV-1) at a ratio of from 70 mol % or more to 100 mol % or less, preferably at a ratio of from 80 mol % or more to 100 mol % or less, and more preferably at a ratio of from 90 mol % or more to 100 mol % or less.

Further, the cyclobutanetetracarboxylic dianhydride used as the raw material forming the polyimide and the polyimide precursor may include at least two kinds of cyclobutanetetracarboxylic dianhydride represented by the chemical formula (IV-1).

Further, the cyclobutanetetracarboxylic dianhydride used as the raw material forming the polyimide and the polyimide precursor may include at least two kinds of cyclobutanetetracarboxylic dianhydride represented by the chemical formulae (D-1) to (D-8).

Further, the cyclobutanetetracarboxylic dianhydride used as the raw material forming polyimide and the polyimide precursor may include at least three kinds of cyclobutanetetracarboxylic dianhydride represented by the chemical formula (IV-1).

Further, the cyclobutanetetracarboxylic dianhydride used as the raw material forming polyimide and the polyimide precursor may include at least three kinds of cyclobutanetetracarboxylic dianhydride represented by the chemical formulae (D-1) to (D-8).

With the above-mentioned configuration, the photoreactivity becomes high, and the alignment stability of liquid crystal is improved.

Hereinafter, examples of the present invention are described in detail with reference to the accompanying drawings. The alignment control film according to the present invention, which is used in the examples, is merely an example, and the same advantages have been confirmed in other structures.

In the following description, a substrate on which an active element such as a thin film transistor is formed is called “active matrix substrate”.

Further, when a counter substrate is provided with a color filter, the substrate is also called “color filter substrate”.

Further, in the present invention, a desired contrast as a target is 500:1 or more, and it is desirable that a target period of time when the residual image is eliminated is 5 minutes or shorter.

The period of time when the residual image is eliminated is determined according to a method defined in the following examples.

Further, according to a preferred example of the present invention, the electrode group in the present invention is formed on only any one of the pair of substrates. That is, according to the preferred example of the present invention, an electric field that is applied to the liquid crystal layer has a component substantially parallel to the substrate surface on which the electrode group is formed.

Further, a long axis direction of liquid crystal molecules forming the liquid crystal layer on the alignment control film in the liquid crystal display device according to the present invention may be parallel or orthogonal to a polarizing axis of an irradiated ray that has been substantially linearly polarized.

Further, it is preferred that a pretilt angle of the liquid crystal layer is 1 degree or lower. Within each cell of the liquid crystal display device, the liquid crystal molecules forming the liquid crystal layer are not only arranged at the identical azimuth, but also inclined at a tilt angle (pretilt angle) of some degree. In order to obtain the high reliability of the liquid crystal display device, it is preferred that the pretilt angle of the liquid crystal molecules forming the liquid crystal layer be 1 degree or lower. The pretilt angle of liquid crystal was measured through a crystal rotation method.

The alignment control film according to the present invention can be also applied in the liquid crystal display device including the active elements.

That is, the alignment control film according to the present invention can be also applied to a liquid crystal display device including: a pair of substrates, at least one of which is transparent; a liquid crystal layer arranged between the pair of substrates; an electrode group formed on at least one of the pair of substrates, for applying an electric field to the liquid crystal layer; a plurality of active elements connected to the electrode group; and an alignment control film arranged on at least one of the pair of substrates.

The active element is a transistor element for writing data, and represented by, for example, a thin film transistor (TFT).

In the examples described later, a TFT liquid crystal display device including the active elements (active matrix liquid crystal display device) is shown. However, the alignment control film according to the present invention can be applied to a liquid crystal display device including no active element, for example, a simple matrix liquid crystal display device (passive matrix liquid crystal display device).

### EXAMPLE 1

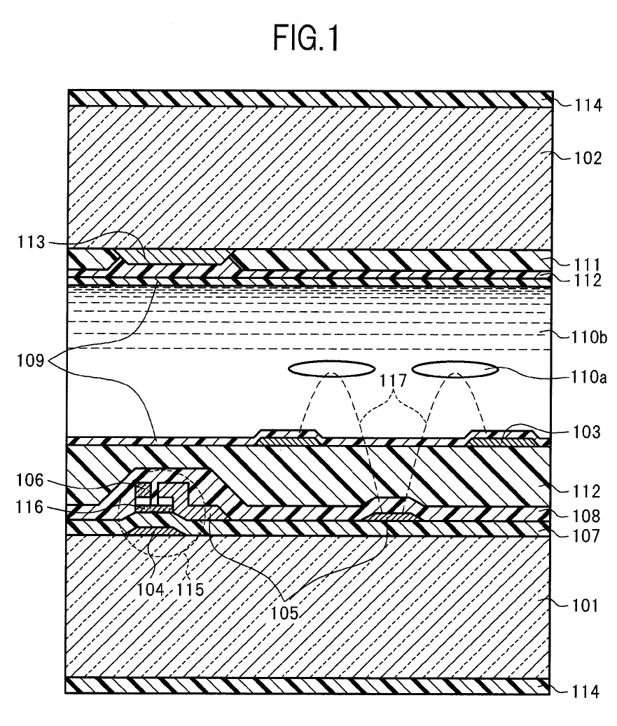

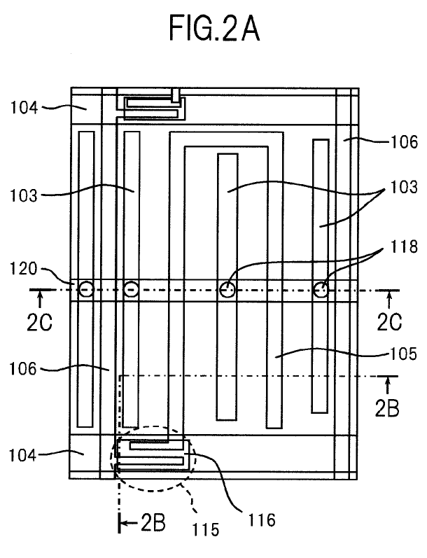

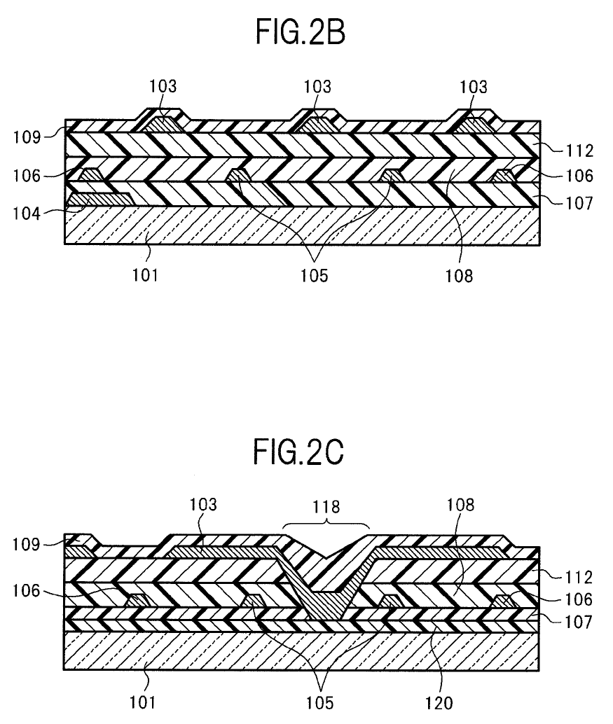

FIG. 1 is a schematic cross-sectional view illustrating a vicinity of one pixel in the liquid crystal display device according to this example. FIGS. 2A to 2C are schematic diagrams of an active matrix substrate illustrating the configuration of the vicinity of one pixel in the liquid crystal display device according to this example, in which FIG. 2A is a plan view, FIG. 2B is a cross-sectional view taken along the line 2B-2B illustrated in FIG. 2A, and FIG. 2C is a cross-sectional view taken along the line 2C-2C illustrated in FIG. 2A. FIG. 1 corresponds to a part of a cross section taken along the line 2B-2B illustrated in FIG. 2A.

FIGS. 2B and 2C schematically emphasize configurations of main portions, and do not correspond one by one to cut portions of the line 2B-2B and the line 2C-2C in FIG. 2A. For example, a semiconductor film 116 is not illustrated in FIG. 2B, and only one through-hole 118 that connects each common electrode 103 and a common electrode line (common line) 120 is representatively illustrated in FIG. 2C.

In this example, scanning lines (gate electrode lines) 104 and the common electrode line 120 which are made of chrome (Cr) are arranged on a glass substrate 101 as the active matrix substrate, and a gate insulating film 107 made of silicon nitride is so formed as to cover the scanning lines 104 and the common electrode line 120. Further, the semiconductor film 116 made of amorphous silicon or polysilicon is arranged above each of the scanning lines 104 through the gate insulating film 107, and functions as an active layer of each thin film transistor (TFT) 115 serving as the active element.

Further, each signal line (drain electrode) 106 and each pixel electrode (source electrode) 105 which are made of chrome/molybdenum (Cr.Mo) are so arranged as to be superimposed on a part of the pattern of the semiconductor film 116, and a protective insulating film 108 made of silicon nitride is so formed as to cover all of those components.

Further, as illustrated in FIG. 2C, the common electrodes 103 that connect to the common electrode line 120 through the through-hole 118 formed through the gate insulating film 107 and the protective insulating film 108 are arranged on an overcoat layer (organic protective film) 112.

Further, as illustrated in FIG. 2A, the common electrodes 103 drawn from the common electrode line 120 through the through-hole 118 are so formed as to face the pixel electrodes 105 in a region of one pixel in a planar fashion.

In this example, the pixel electrodes 105 are arranged below the protective insulating film 108 which is disposed below the organic protective film 112, and the common electrodes 103 are arranged on the organic protective film 112. One pixel is configured in a region sandwiched between the plurality of pixel electrodes 105 and the common electrodes 103.

Further, an alignment control film 109 is formed on a surface of the active matrix substrate on which the unit pixels configured as described above are arranged in matrix, that is, on the organic protective film 112 on which the common electrodes 103 are formed.

On the other hand, as illustrated in FIG. 1, a color filter layer 111 is arranged on the glass substrate 102 constituting the counter substrate so as to be partitioned by a light shield film (black matrix) 113 for each pixel. Further, the color filter layer 111 and the light shield film 113 are covered with the organic protective film 112 made of a transparent insulating material. Further, the alignment control film 109 is also formed on the organic protective film 112 to configure a color filter substrate.

Those alignment control films 109 are imparted liquid crystal alignment capability by irradiation of linearly polarized ultraviolet rays which are extracted with the use of a pile polarizer in which quartz plates are laminated on each other with a high-pressure mercury lamp as a light source.

The glass substrate 101 constituting the active matrix substrate and the glass substrate 102 constituting the color filter substrate are arranged to face each other at the surfaces of the alignment control films 109, and a liquid crystal layer (liquid crystal composition layer) 110b made up of liquid crystal molecules 110a are arranged between the glass substrate 101 and the glass substrate 102.

Further, on the respective outer surfaces of the glass substrate 101 constituting the active matrix substrate and the glass substrate 102 constituting the color filter substrate, polarization plates 114 are formed.

In the above-mentioned manner, the TFT liquid crystal display device (active matrix liquid crystal display device) using the thin film transistor (TFT) is configured.

In the TFT liquid crystal display device, the liquid crystal molecules 110a constituting the liquid crystal composition layer 110b are aligned substantially in parallel to the surfaces of the glass substrates 101 and 102 which face each other at the time of applying no electric field. The liquid crystal molecules 110a are homogeneously aligned in a state in which the liquid crystal molecules 110a are directed in an initial alignment direction regulated by the photo-alignment process.

In this example, when a voltage is applied to the scanning lines 104 to turn on the thin film transistor 115, an electric field 117 is applied to the liquid crystal composition layer 110b due to a potential difference between the pixel electrode 105 and the common electrodes 103. The liquid crystal molecules 110a constituting the liquid crystal composition layer 110b is turned to the electric field direction due to an interaction of a dielectric anisotropy of the liquid crystal composition layer 110b and the electric field. In this situation, the a refractive anisotropy of the liquid crystal composition layer 110b and the action of the polarization plates 114 can change the light transmittance of the liquid crystal display device for display.

Further, the organic protective film 112 can be made of a thermosetting resin such as an acrylic resin, an epoxy acrylic resin or a polyimide resin which are excellent in the insulating property and the transparency. Further, the organic protective film 112 can be made of a light curing transparent resin, or an inorganic material such as a polysiloxane resin. Further, the organic protective film 112 can also function as the alignment control film 109.

As described above, according to this example, the liquid crystal alignment control capability of the alignment control film 109 is performed by using not the rubbing alignment process that directly rubs the alignment control film 109 with a buff cloth, but the non-contact photo-alignment method. As a result, uniform alignment can be given to the entire surface of the display region without local disturbance of alignment in the vicinity of the electrodes.

In general, in the in-plane switching (IPS) system, no interface tilt with the substrate surface is required in principle unlike the vertical electric field system represented by the conventional twisted nematic (TN) system. It is known that the viewing angle characteristic is more improved as the interface tilt angle becomes smaller. The smaller interface tilt angle is desired even in the photo-alignment control film. In particular, when the interface tilt angle is set to 1 degree or lower, a change in color and brightness due to the viewing angle of the liquid crystal display device can be remarkably suppressed, which is effective.

Subsequently, as a method of manufacturing the liquid crystal display device according to this example, formation of the alignment control film by using the rubbingless alignment method of the liquid crystal alignment control film is described. A flow of a process for forming the alignment control film according to this example includes the following steps (1) to (4). (1) Coating and formation of the alignment control film (a uniform film is coated on the entire surface of the display region). (2) Imidization baking of the alignment control film (removal of varnish solvent and polyimidization high in heat resistance are enhanced). (3) Impartation of the liquid crystal alignment capability by irradiation of the polarized light (the uniform alignment capability is imparted to the display region). (4) Enhancement and stabilization of the alignment capability (by heating, infrared radiation, far infrared radiation, electron beam irradiation, and radiation exposure).

The alignment control film is formed through the above-mentioned four processes. However, the present invention is not limited to the order of the processes of the above-mentioned (1) to (4). Moreover, further advantages are expected in the case of the following processes (a) and (b). (a) The above-mentioned processes (3) and (4) are so processed as to temporally overlap with each other to accelerate the liquid crystal alignment capability impartation and induce the cross-linking reaction. As a result, the alignment control film can be further effectively formed. (b) In the case of using the heating, the infrared radiation, and the far infrared radiation of the above-mentioned process (4), the above-mentioned processes (2), (3) and (4) are allowed to temporally overlap with each other. As a result, the above-mentioned process (4) can also function as the imidization process of the above-mentioned process (2), and hence the alignment control film can be formed in a short time.

Subsequently, a specific manufacturing method according to this example is described. A glass substrate having a thickness of 0.7 mm whose surface has been polished is used as the glass substrate 101 constituting the active matrix substrate and the glass substrate 102 constituting the color filter substrate. The thin film transistor 115 formed on the glass substrate 101 includes the pixel electrode (source electrode) 105, the signal line (drain electrode) 106, the scanning line (gate electrode line) 104, and the semiconductor film (amorphous silicon film) 116.

All of the scanning lines 104, the common electrode line 120, the signal line 106, and the pixel electrode 105 were formed by patterning a chrome film, and an interval between the pixel electrode 105 and the common electrode 103 was set to 7 μm. The common electrodes 103 and the pixel electrode 105 were formed by using the chrome film which is low in resistance and easy in patterning. Alternatively, a transparent electrode may be formed by using an indium tin oxide (ITO) film to achieve the higher brightness characteristic.

The gate insulating film 107 and the protective insulating film 108 were made of silicon nitride, and the respective thicknesses were set to 0.3 μm. An acrylic resin was coated on those films, and a heat treatment at 220° C. for 1 hour was conducted to form the transparent and insulating organic protective film 112.

Then, the through-hole 118 was formed up to the common electrode line 120 through the photolithography and etching process as illustrated in FIG. 2C, and the common electrodes 103 that connect to the common electrode line 120 were formed by patterning.

As a result, as illustrated in FIG. 2A, the pixel electrode 105 was arranged among the three common electrodes 103 within the unit pixel (one pixel) to form the active matrix substrate which has 1024×3×768 in the number of pixels, which includes 1024×3 (corresponding to R, G, and B) signal lines 106 and 768 scanning lines 104.

In this example, various polyamide acids 1-1 to 1-5 synthesized in accordance with the raw material compositions shown in Table 1 below were used for the alignment control film 109. Then, those alignment control films were used to manufacture five liquid crystal display devices. The polyamide acid was used to prepare a varnish with a resin concentration of 5 wt %, dimethyl acetamide (DMAC) of 60 wt %, γ-butyrolactone of 20 wt %, and butyl cellosolve of 15 wt %. The varnish was printed on an active matrix substrate, and imidized through a heat treatment, to thereby form a dense alignment control film 109 made of a polyimide and a polyamide acid amide with an imidization ratio of about 80% and a thickness of about 70 nm.

TABLE 1

Diamine compounds

| Alignment | Group of | Group of | Tetracarboxylic |
|---|---|---|---|
| control | compounds I | compounds II | dianhydrides |
| film No. | (mol %) | (mol %) | (mol %) |
| 1-1 | A-1 (70) | B-4 (30) | D-1 (100) |
| 1-2 | A-4 (65) | B-9 (35) | D-5 (100) |
| 1-3 | A-8 (85) | B-13 (15) | D-4 (100) |
| 1-4 | A-22 (60) | B-17 (40) | D-7 (100) |
| 1-5 | A-59 (90) | B-19 (10) | D-5 (100) |

Likewise, the same polyamide acid amide varnish was also printed on the surface of another glass substrate 102 on which the ITO has been formed, to thereby form the dense alignment control film 109 made of polyimide and polyamide acid amide with the imidization ratio of about 80% and the thickness of about 70 nm.

In order to impart the liquid crystal alignment capability to the surface of the alignment control film 109, polarized UV (ultraviolet) rays were applied onto the alignment control film 109. With the use of a high-pressure mercury lamp as the light source, the UV rays in a range of 240 nm to 380 nm were extracted through an interference filter. The extracted UV rays were linearly polarized at the polarization ratio of about 10:1 by using a pile polarizer in which quartz substrates were laminated on each other, and applied with the irradiation energy of about 5 J/cm².

As a result, it was found that the alignment direction of the liquid crystal molecules on the alignment control film surface was orthogonal to the polarization direction of the irradiated polarized UV rays.

Then, those two glass substrates 101 and 102 were faced each other at the surfaces having the respective alignment control films 109 with the liquid crystal alignment capability. Spacers formed of dispersed spherical polymer beads were interposed between those glass substrates 101 and 102, and a sealing material was coated on the peripheral portions of the glass substrates 101 and 102, to thereby assemble a liquid crystal display panel (hereinafter, referred to as “cell”) forming the liquid crystal display device.

The liquid crystal alignment directions of the two glass substrates were substantially parallel to each other. A nematic liquid crystal composition A which was positive in the dielectric anisotropy Δε, 10.2 (1 kHz, 20° C.) in the value of the dielectric anisotropy, 0.075 (wavelength 590 nm, 20° C.) in the refractive anisotropy Δn, 7.0 pN in twisted elastic constant K2, and about 76° C. in nematic-to-isotropic transition temperature T(N−1) was injected into the cell in a vacuum, and sealed with a sealing material made of an ultraviolet curable resin. A liquid crystal panel in which a thickness (gap) of the liquid crystal layer was 4.2 μm was manufactured.

The retardation (Δn·d) of this liquid crystal display panel is about 0.31 μm. It is desirable that Δn·d satisfies a range of 0.2 μm≦Δn·d≦0.5 μm, and when Δn·d exceeds this range, there arises such a problem that white display is colored.

Further, a liquid crystal display panel of a homogeneous alignment was manufactured by using the same alignment control film and the liquid crystal composition as those used in the above-mentioned panel, and the pretilt angle of liquid crystal was measured through a crystal rotation method. The measurement result was about 0.2 degrees.

This liquid crystal display panel was sandwiched between the two polarization plates 114 so that the polarization transmission axis of one polarization plate was so arranged to be substantially parallel to the above-mentioned liquid crystal alignment direction, and the polarization transmission axis of the other polarization plate was so arranged to be orthogonal to the former polarization transmission axis. After that, a drive circuit, a backlight, and so on were connected for modulation to obtain the active matrix liquid crystal display device. In this example, a normally close characteristic in which dark display is established with a low voltage, and bright display is established with a high voltage was provided.

As a result of evaluating the display quality of the five liquid crystal display devices according to this example, the high-grade display of 500:1 in the contrast ratio was confirmed. Further, the wide viewing angle during the halftone display was confirmed.

Further, in order to quantitatively measure the image-sticking and the residual image of the five liquid crystal display devices according to this example, an oscilloscope having the combination of photodiodes was used for evaluation.

First, a window pattern was displayed on a screen with the maximum brightness for 10 hours. After that, the entire screen was switched to the halftone display where the residual image was most visible, that is, in this example, the brightness of 10% of the maximum brightness. The display quality was evaluated with a time until the pattern of an edge portion of the window pattern was eliminated as a residual image relaxation time. The residual image relaxation time permitted in this example is 5 minutes or shorter.

As a result, the residual image relaxation time was 1 minute or shorter in the use temperature range (0° C. to 50° C.). Even in the visual image quality residual image test, the sticking of the image and the display unevenness caused by the residual image were not found at all. Further, the high display characteristic was obtained.

### EXAMPLE 2

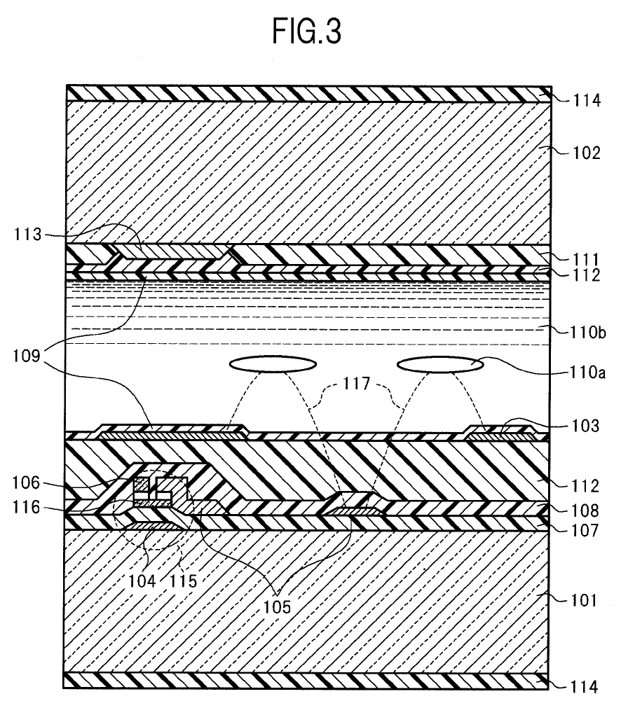

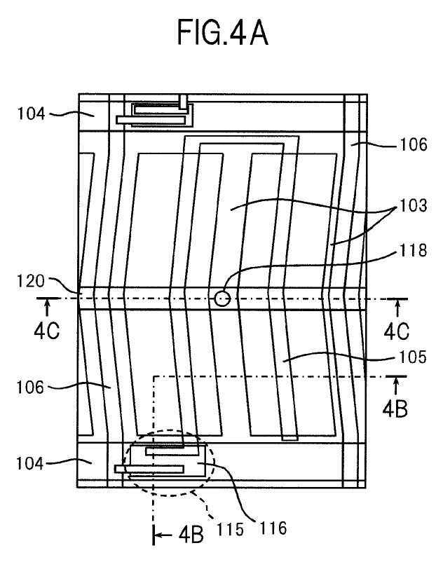

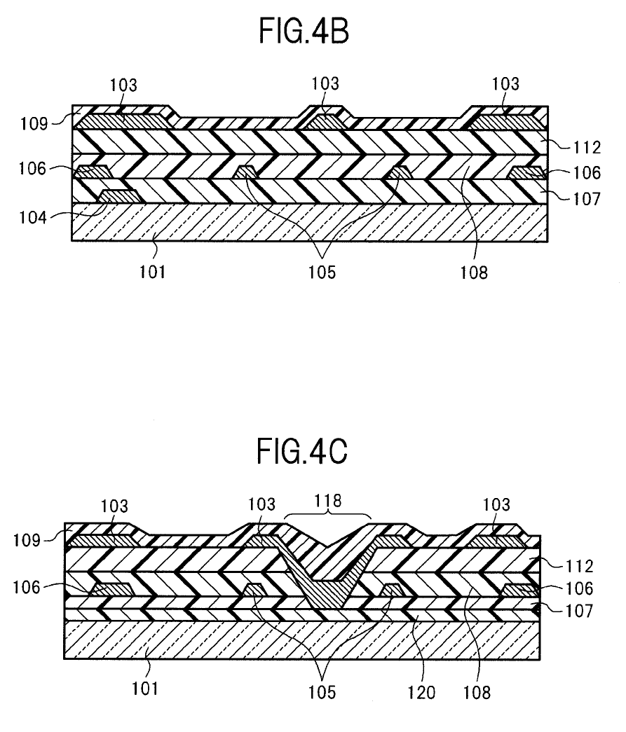

FIG. 3 is a schematic cross-sectional view illustrating a vicinity of one pixel in the liquid crystal display device according to this example. FIGS. 4A to 4C are schematic diagrams of an active matrix substrate illustrating the configuration of the vicinity of one pixel in the liquid crystal display device according to this example, in which FIG. 4A is a plan view, FIG. 4B is a cross-sectional view taken along the line 4B-4B illustrated in FIG. 4A, and FIG. 4C is a cross-sectional view taken along the line 4C-4C illustrated in FIG. 4A. FIG. 3 corresponds to a part of a cross section taken along the line 4B-4B illustrated in FIG. 4A.

FIGS. 4B and 4C schematically emphasize configurations of main portions, and do not correspond one by one to cut portions of the line 4B-4B and the line 4C-4C in FIG. 4A. For example, the semiconductor film 116 is not illustrated in FIG. 4B. In this example, the scanning lines 104 and the common electrode line 120 which are made of Cr are arranged on the glass substrate 101 constituting the active matrix substrate, and the gate insulating film 107 made of silicon nitride is so formed as to cover the scanning lines 104 and the common electrode line 120.

Further, the semiconductor film 116 made of amorphous silicon or polysilicon is arranged above each of the scanning lines 104 through the gate insulating film 107, and functions as an active layer of each thin film transistor 115 serving as the active element.

Further, each drain electrode 106 and each source electrode (pixel electrode) 105 which are made of chrome/molybdenum are so arranged as to be superimposed on a part of the pattern of the semiconductor film 116, and the protective insulating film 108 made of silicon nitride is so formed as to cover all of those components. The organic protective film 112 is arranged on the protective insulating film 108. The organic protective film 112 is made of, for example, a transparent material such as an acrylic resin.

Further, the pixel electrode 105 is formed of a transparent electrode made of ITO (In₂O₃:Sn).

The common electrode 103 is connected to the common electrode line 120 through the through-hole 118 that passes through the gate insulating film 107, the protective insulating film 108, and the organic protective film 112.

In the case of applying an electric field for driving the liquid crystal, the common electrode 103 paired with the pixel electrode 105 is so formed as to surround the region of one pixel in a planar fashion.

Further, the common electrode 103 is arranged on the organic protective film 112. The common electrode 103 is so arranged as to cover the drain electrode 106, the scanning line 104, and the thin film transistor 115 which is an active element, which are disposed below when being viewed from the top. The common electrode 103 also functions as a light shield layer that shields light from the semiconductor film 116.

The alignment control film 109 is formed on the surface of the glass substrate 101 constituting the active matrix substrate in which the unit pixels (one pixel) configured as described above are arranged in matrix, that is, on the organic protective film 112 and the common electrode 103 formed on the organic protective film 112.

On the other hand, on the glass substrate 102 constituting the counter substrate, the alignment control film 109 is formed on the organic protective film 112 formed on the color filter layer 111.

In this example, like Example 1, the liquid crystal alignment capability is imparted to the alignment control film 109 by irradiation of linearly polarized ultraviolet rays which are extracted with the use of a pile polarizer in which quartz plates are laminated on each other with a high-pressure mercury lamp as a light source.

The glass substrate 101 and the counter glass substrate 102 are arranged to face each other at the surfaces where the alignment control films 109 are formed, and the liquid crystal composition layer 110b made up of liquid crystal molecules 110a are arranged between the glass substrate 101 and the counter glass substrate 102.

Further, the polarization plates 114 are formed on the respective outer surfaces of the glass substrate 101 and the counter glass substrate 102.

As described above, also in this example, like the above-mentioned Example 1, the pixel electrode 105 is arranged below the organic protective film 112 and the protective insulating film 108, and the common electrode 103 is arranged above the pixel electrode 105 and the organic protective film 112.

Further, when the electric resistance of the common electrode 103 is sufficiently low, the common electrode 103 can also function as the common electrode line 120 formed in the lowest layer. In this case, the formation of the common electrode line 120 disposed in the lowest layer and the processing of the through-hole 118 accompanied by the formation of the common electrode line 120 can be omitted.

In this example, as illustrated in FIG. 4A, one pixel is configured by a region surrounded by the common electrodes 103 formed in a lattice, and one pixel is divided into four regions together with the pixel electrode 105.

Further, the pixel electrode 105 and the common electrodes 103 that face the pixel electrode 105 are of a zigzag bent structure where those components are arranged in parallel to each other. One pixel forms a plurality of sub-pixels of two or more. With this structure, a change in color tone within the plane is offset.

Subsequently, a manufacturing method of the liquid crystal display device according to this example is described. A glass substrate having a thickness of 0.7 mm whose surface has been polished is used as the glass substrate 101 and the glass substrate 102. The thin film transistor 115 includes the pixel electrode (source electrode) 105, the signal line (drain electrode) 106, the scanning line (gate electrode line) 104, and the semiconductor film (amorphous silicon film) 116.

The scanning line 104 was formed by patterning an aluminum film, the common electrode line 120 and the signal line 106 were formed by patterning a chrome film, and the pixel electrode 105 was formed by patterning an ITO film. As illustrated in FIG. 4A, the components other than the scanning line 104 were formed into electrode line patterns which were bent in zigzag.

In this situation, an angle of bending was set to 10 degrees. The gate insulating film 107 and the protective insulating film 108 were made of silicon nitride, and the respective thicknesses were set to 0.3 μm.

Then, as illustrated in FIG. 4C, the through-hole 118 having a diameter of about 10 μm was formed into a cylindrical shape through the photolithography method and the etching process so as to extend up to the common electrode line 120. An acrylic resin was coated on the through-hole 118, and a heat treatment was performed at 220° C. for one hour to form the transparent and insulating organic protective film 112 which was about 4 in dielectric constant at a thickness of about 1 μm.

The roughness caused by a step of the pixel electrode 105 in the display region was flattened by the organic protective film 112. Further, the roughness caused by a step at a boundary portion of the color filter layer 111 between the adjacent pixels was flattened by the organic protective film 112.

After that, the through-hole 118 was again etched to have a diameter of about 7 μm, and the common electrode 103 connected to the common electrode line 120 was formed on the through-hole 118 by patterning an ITO film. In this situation, the interval between the pixel electrode 105 and the common electrode 103 was set to 7 μm.

Further, the common electrodes 103 were formed in a lattice so as to cover the upper portions of the signal line 106, the scanning lines 104, and the thin film transistor 115, and to surround the pixel, and also were formed so as to function as the light shield layer.

As a result, within the unit pixel, as illustrated in FIG. 4A, the pixel electrode 105 was arranged among the three common electrodes 103 to obtain the active matrix substrate which is 1024×3×768 in the number of pixels, including 1024×3 (corresponding to R, G, and B) signal lines 106 and 768 scanning lines 104.

In this example, various polyamide acid methyl esters 2-1 to 2-3 synthesized in accordance with the raw material compositions shown in Table 2 below were used for the alignment control film 109. Then, those alignment control films were used to manufacture three liquid crystal display devices.

The polyamide acid was used to prepare a varnish with a resin concentration of 5 wt %, DMAC of 60 wt %, γ-butyrolactone of 20 wt %, and butyl cellosolve of 15 wt %. The varnish was printed on an active matrix substrate, and imidized through a heat treatment to form a dense alignment control film 109 made of a polyimide and a polyamide acid amide with an imidization ratio of about 80% and a thickness of about 60 nm.

TABLE 2

Diamine compounds

| Alignment | Group of | Group of | Tetracarboxylic |
|---|---|---|---|
| control | compounds I | compounds II | dianhydrides |
| film No. | (mol %) | (mol %) | (mol %) |
| 2-1 | A-1 (40) | B-4 (10) | D-2 (100) |
| | A-12 (30) | B-11 (20) | |
| 2-2 | A-4 (45) | B-9 (20) | D-3 (100) |
| | A-21 (20) | B-13 (15) | |
| 2-3 | A-8 (30) | B-13 (10) | D-6 (100) |
| | A-28 (55) | B-19 (5) | |

In the aligning method, the same polarized UV as that in Example 1 was applied with the irradiation energy of about 3 J/cm². During the irradiation of the polarized UV, the substrate on which the alignment control film had been formed was subjected to a heat treatment on a hot plate to about 150° C. at the same time.

Then, those two glass substrates are faced each other at the surfaces having the liquid crystal alignment films. Spacers formed of dispersed spherical polymer beads were interposed between those glass substrates, and a sealing material was coated on the peripheral portions of the glass substrates to assemble a liquid crystal display panel. The liquid crystal alignment directions of those two glass substrates were substantially parallel to each other.

A nematic liquid crystal composition A which was positive in the dielectric anisotropy Δε, 10.2 (1 kHz, 20° C.) in the value of the dielectric anisotropy, 0.075 (wavelength 590 nm, 20° C.) in the refractive anisotropy Δn, 7.0 pN in twisted elastic constant K2, and about 76° C. in nematic-to-isotropic transition temperature T(N−1) was injected into the liquid crystal display panel in a vacuum, and sealed with a sealing material made of an ultraviolet curable resin.

A liquid crystal panel in which a thickness (gap) of the liquid crystal layer was 4.2 μm was manufactured. The retardation (And) of this panel is about 0.31 μm.

Further, a liquid crystal display panel of a homogeneous alignment was manufactured by using the same alignment control film and the liquid crystal composition as those used in the above-mentioned liquid crystal display panel, and the pretilt angle of liquid crystal was measured through a crystal rotation method. The measurement result was about 0.2 degrees.

This liquid crystal display panel was sandwiched between the two polarization plates 114 so that the polarization transmission axis of one polarization plate was so arranged to be substantially parallel to the above-mentioned liquid crystal alignment direction, and the polarization transmission axis of the other polarization plate was so arranged to be orthogonal to the former polarization transmission axis.

After that, a drive circuit, a backlight, and so on were connected for modulation to obtain the active matrix liquid crystal display device. In this example, a normally close characteristic in which dark display is established with a low voltage, and bright display is established with a high voltage was provided.

As a result of evaluating the display quality of the three liquid crystal display devices according to this example, the aperture ratio was higher than that in the liquid crystal display device of Example 1, and the high-grade display of 600:1 in the contrast ratio was confirmed. Further, the wide viewing angle during the halftone display was confirmed. Further, as a result of quantitatively evaluating the image-sticking and the residual image relaxation time of the liquid crystal display devices as in Example 1, the residual image relaxation time was about 1 minute in the use temperature range of 0° C. to 50° C., and even in the visual image quality residual image test, the sticking of the image, and the display unevenness caused by the residual image were not found at all, and the high display characteristic equivalent to Example 1 was obtained.

### EXAMPLE 3

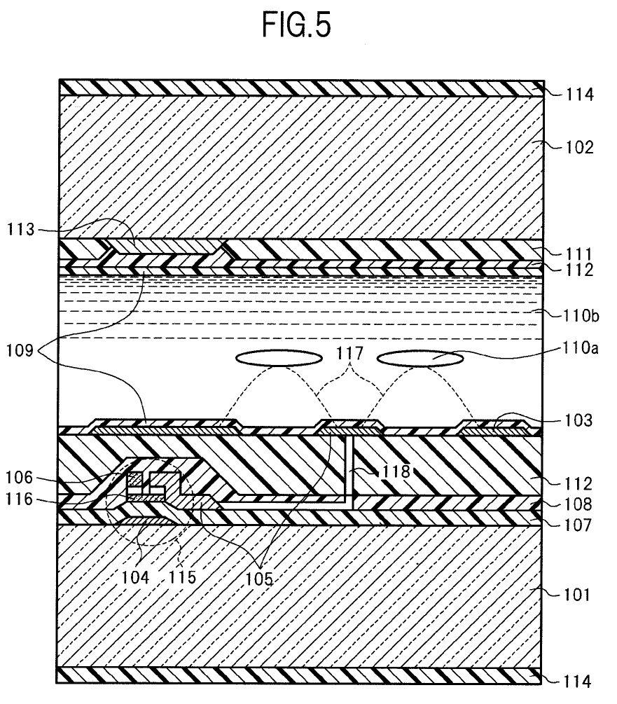

FIG. 5 is a schematic cross-sectional view of the vicinity of one pixel in a liquid crystal display device according to this example. In FIG. 5, the same symbols as those in the above-mentioned respective examples correspond to identical function portions.

As illustrated in FIG. 5, in this example, the pixel electrode 105 disposed below the protective insulating film 108 is pulled up to the upper surface of the organic protective film 112 through the through-hole 118 so as to be arranged in the same layer as that of the common electrode 103. In this configuration, a voltage for driving the liquid crystal can be further reduced.

In the TFT liquid crystal display device configured as described above, at the time of applying no electric field, the liquid crystal molecules 110a constituting the liquid crystal composition layer 110b are aligned substantially in parallel to the surfaces of the glass substrates 101 and 102 which face each other. The liquid crystal molecules 110a are homogeneously aligned in a state where the liquid crystal molecules 110a are directed in an initial alignment direction regulated by the photo-alignment process.

In this example, when a voltage is applied to the scanning lines 104 to turn on the thin film transistor 115, an electric field 117 is applied to the liquid crystal composition layer 110b due to a potential difference between the pixel electrode 105 and the common electrode 103. The liquid crystal molecules 110a turns to the electric field direction due to an interaction of a dielectric anisotropy of the liquid crystal composition and the electric field. In this situation, the dielectric anisotropy of the liquid crystal composition layer 110b and the action of the polarization plates 114 can change the light transmittance of the liquid crystal display device for display.

Hereinafter, a method of manufacturing the liquid crystal display device according to this example is described. As the glass substrates 101 and 102, glass substrates each having a thickness of 0.7 mm whose surfaces have been polished are used. The thin film transistor 115 includes the pixel electrode (source electrode) 105, the signal line (drain electrode) 106, the scanning line (gate electrode line) 104, and the semiconductor film (amorphous silicon film) 116.

The scanning lines 104 were formed by patterning an aluminum film. The common electrode line 120, the signal line 106, and the pixel electrode 105 were formed by patterning a chrome film.

The gate insulating film 107 and the protective insulating film 108 were made of silicon nitride, and the respective thicknesses were set to 0.3 μm. An acrylic resin was coated on those films, and a heat treatment was performed at 220° C. for one hour to form the transparent and insulating organic protective film 112 which was about 4 in the dielectric constant at a thickness of about 1.0 μm. The roughness caused by a step of the pixel electrode 105 in the display region was flattened by the organic protective film 112. Further, the roughness caused by a step between the adjacent pixels was flattened by the organic protective film 112.

Then, as illustrated in FIG. 5, the through-hole 118 having a diameter of about 10 μm was formed into a cylindrical shape through the photolithography method and the etching process so as to extend up to the pixel electrode (source electrode) 105 disposed below the protective insulating film 108. The pixel electrode 105 disposed in the same layer as the common electrode 103, which was connected to the pixel electrode (source electrode) 105 disposed below the protective insulating film 108, was formed by patterning an ITO film on the upper portion of the through-hole 118.

Further in the common electrode line 120, a through-hole was formed into a cylindrical shape with a diameter of about 10 μm, and an ITO film was patterned on the upper portion of the through-hole to form the common electrode 103. In this situation, the interval between the pixel electrode 105 and the common electrode 103 was set to 7 μm, and the components other than the scanning lines 104 were formed into electrode line patterns which were bent in zigzag.

In this situation, an angle of bending was set to 10 degrees. Further, the common electrodes 103 were formed in a lattice so as to cover the upper portions of the signal line 106, the scanning lines 104, and the thin film transistor 115, and to surround the pixels. Thus, the common electrode 103 also functions as the light shield layer.

Except that two kinds of through-holes were formed within the unit pixel, the pixel electrode 105 was arranged among the three common electrodes 103 substantially in the same manner as that of Example 2. With this configuration, the active matrix substrate which were 1024×3×768 in the number of pixels, and made up of 1024×3 (corresponding to R, G, and B) signal lines 106 and 768 scanning lines 104 was formed.

As described above, the liquid crystal display device was manufactured in the same manner as that of Example 2 as illustrated in FIG. 5, except for the pixel structure and the alignment control film used in this example.

In this example, various polyamide acid propyl esters 3-1 to 3-3 synthesized in accordance with the raw material compositions shown in Table 3 below were used for the alignment control film 109. Then, those alignment control films were used to manufacture three liquid crystal display devices.

The polyamide acid was used to prepare a varnish with a resin concentration of 5 wt %, DMAC of 60 wt %, γ-butyrolactone of 20 wt %, and butyl cellosolve of 15 wt %. The varnish was printed on an active matrix substrate, and imidized through a heat treatment to form a dense alignment control film 109 made of a polyimide and a polyamide acid amide with an imidization ratio of about 80% and a thickness of about 60 nm.

TABLE 3

Diamine compounds

| Alignment | Group of | Group of | Tetracarboxylic |
|---|---|---|---|
| control | compounds I | compounds II | dianhydride |
| film No. | (mol %) | (mol %) | (mol %) |
| 3-1 | A-7 (20) | B-5 (5) | D-8 (100) |
| | A-15 (30) | B-6 (20) | |
| | A-19 (20) | B-13 (5) | |
| 3-2 | A-23 (45) | B-2 (10) | D-1 (100) |
| | A-39 (10) | B-13 (15) | |
| | A-34 (10) | B-17 (10) | |
| 3-3 | A-20 (20) | B-4 (5) | D-4 (100) |
| | A-41 (55) | B-15 (5) | |
| | A-58 (10) | B-20 (5) | |

In the aligning method, the same polarized UV as that in Example 1 was applied with the irradiation energy of about 6 J/cm². During the irradiation of the polarized UV, the substrate on which the alignment control film had been formed was subjected to a heat treatment on a hot plate to about 180° C. at the same time.

Then, as a result of evaluating the display quality of the three liquid crystal display devices according to this example, the high-grade display equivalent to Example 1 was confirmed. Further, the wide viewing angle during the halftone display was confirmed.

Further, as a result of quantitatively evaluating the image-sticking and the residual image relaxation time of the liquid crystal display devices according to this example as in Example 1, the residual image relaxation time was about 1 minute or shorter, and even in the visual image quality residual image test, the sticking of the image and the display unevenness caused by the residual image were not found at all, and the high display characteristic was obtained.

As illustrated in FIG. 5, in the case where the pixel electrode 105 connected directly to the thin film transistor 115 is formed on the uppermost surface of the substrate, and the thin alignment control film 109 is formed on the pixel electrode 105, when a normal rubbing alignment processing is performed, electrostatic charge is generated due to rubbing, with the result that the thin film transistor 115 maybe damaged in some cases through the pixel electrode in the vicinity of the upper surface.

In this case, the rubbingless photo-alignment process as in this example is very effective.

### EXAMPLE 4

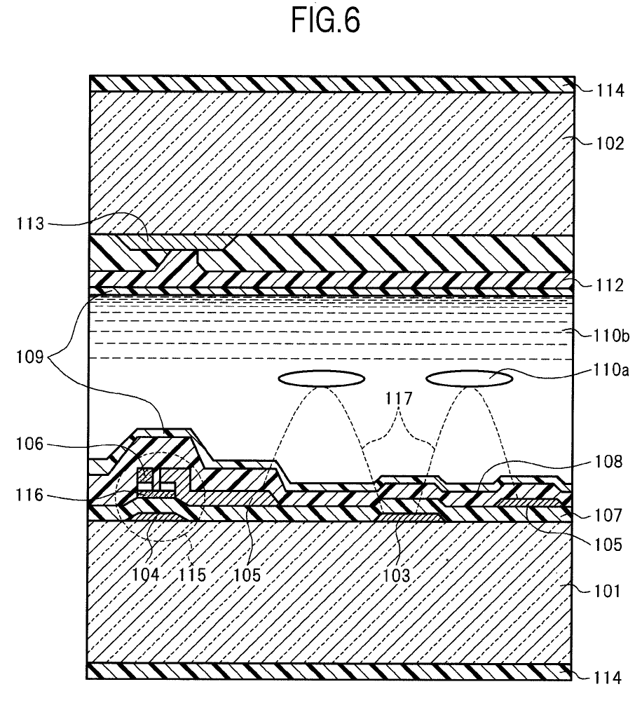

FIG. 6 is a schematic cross-sectional view of the vicinity of one pixel in a liquid crystal display device according to this example. In FIG. 6, the same symbols as those in the above-mentioned respective examples correspond to identical function portions. This example employs a configuration in which a step due to electrodes and the like is large.

Referring to FIG. 6, the common electrode 103 and the scanning line 104 of each thin film transistor 115 are formed in the same layer, and the liquid crystal molecules 110a turn to the electric field direction due to the electric field 117 caused by the common electrode 103 and the pixel electrode 105.

Further, in the above-mentioned respective examples, a plurality of display regions, each of which is made up of the common electrode 103 and the pixel electrode 105, can be provided in one pixel. When the plurality of display regions are provided in this manner, even if one pixel is larger, a distance between the pixel electrode 105 and the common electrode 103 can be shortened. Therefore, a voltage to be applied for driving the liquid crystal can be decreased.

Further, in the above-mentioned respective examples, a material of the transparent conductive film constituting at least one of the pixel electrode and the common electrode is not particularly restricted. However, taking the ease of processing and high reliability into consideration, it is desirable to use ion-doped titanium oxide or ion-doped zinc oxide as in ITO.

In the method of manufacturing the liquid crystal display device according to this example, glass substrates each having a thickness of 0.7 mm whose surfaces have been polished are used as the glass substrates 101 and 102. The thin film transistor 115 includes the pixel electrode (source electrode) 105, the signal line (drain electrode) 106, the scanning line (gate electrode line) 104, and the semiconductor film (amorphous silicon film) 116.

All of the scanning line 104, the common electrode line 120, the signal line 106, the pixel electrode 105, and the common electrode 103 were formed by patterning a chrome film, and an interval between the pixel electrode 105 and the common electrodes 103 was set to 7 μm. The gate insulating film 107 and the protective insulating film 108 were made of silicon nitride, and the respective thicknesses were set to 0.3 μm.

In this example, various polyamide acids 4-1 to 4-5 synthesized in accordance with the raw material compositions shown in Table 4A below were used for the alignment control film 109. Then, those alignment control films were used to manufacture five liquid crystal display devices.

The polyamide acid was used to prepare a varnish with a resin concentration of 5 wt %, DMAC of 60 wt %, γ-butyrolactone of 20 wt %, and butyl cellosolve of 15 wt %. The varnish was printed on an active matrix substrate, and imidized through a heat treatment to form a dense alignment control film 109 made of a polyimide and a polyamide acid amide with an imidization ratio of about 80% and a thickness of about 100 nm.

TABLE 4A

Diamine compounds

| Alignment | Group of | Group of | Tetracarboxylic |
|---|---|---|---|
| control | compounds I | compounds II | dianhydrides |
| film No. | (mol %) | (mol %) | (mol %) |
| 4-1 | A-1 (95) | B-3 (5) | D-4 (100) |
| 4-2 | A-1 (75) | B-3 (25) | D-4 (100) |
| 4-3 | A-1 (50) | B-3 (50) | D-4 (100) |
| 4-4 | A-1 (40) | B-3 (60) | D-4 (100) |
| 4-5 | A-1 (30) | B-3 (70) | D-4 (100) |

After that, light from a high-pressure mercury lamp is allowed to pass through an interference filter and a pile polarizer of quartz to irradiate a polarized UV ray in a wavelength range of 220 nm to 380 nm with an irradiation energy of about 3 J/cm² to conduct the photo-alignment process while irradiating infrared rays. As a result, the active matrix substrate which are 1024×3×768 in the number of pixels, including 1024×3 (corresponding to R, G, and B) signal lines 106 and 768 scanning lines 104, was formed.

As described above, the liquid crystal display device according to this example illustrated in FIG. 6 was manufactured in the same manner as that of Example 1 except for the pixel structure.

As a result of quantitatively evaluating the contrast ratio and the residual image relaxation time in the five liquid crystal display devices according to this example as in Example 1, the results shown in Table 4B below were obtained.

TABLE 4B

| Alignment | | |
|---|---|---|
| control | Contrast | Residual image |
| film No. | ratio | relaxation time |
| 4-1 | 600 | 3 minutes |
| 4-2 | 630 | 2 minutes |
| 4-3 | 510 | 4 minutes |
| 4-4 | 370 | 7 minutes |
| 4-5 | 120 | 30 minutes |

From the results of Table 4B, the liquid crystal display devices using the alignment control films 4-1 to 4-3 were excellent in both of the contrast ratio and the residual image relaxation time. From the above-mentioned viewpoint, it is desirable that diamine selected from the group of compounds I be 50 mol % or more.

### EXAMPLE 5

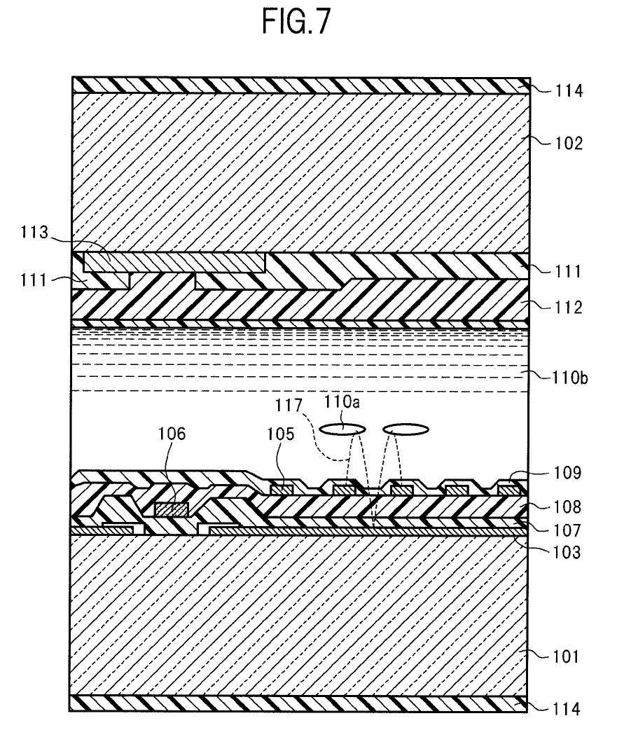

FIG. 7 is a schematic cross-sectional view of the vicinity of one pixel in a liquid crystal display device according to this example. In FIG. 7, the same symbols as those in the above-mentioned respective examples correspond to identical function portions.

In this example, the pixel electrode 105 and the common electrode 103 are made of ITO, and the common electrode 103 is formed of a solid electrode that covers the substantially entire pixel. With this configuration, the electrode can be also used as a transmission portion so that the aperture ratio can be improved.

Further, the electrode interval can be shortened, and hence the electric field can be efficiently applied to the liquid crystal.

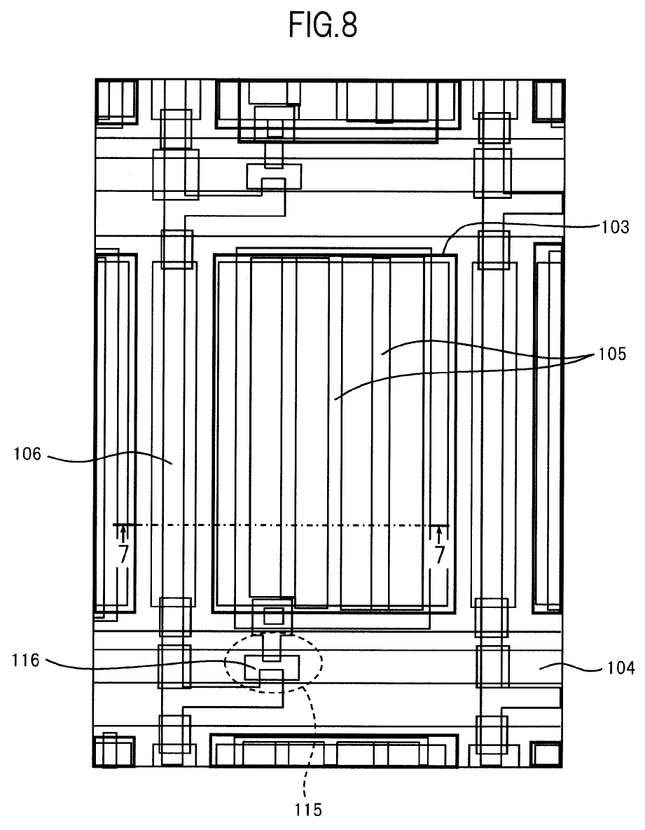

FIG. 8 is a schematic diagram of an active matrix substrate illustrating the configuration of the vicinity of one pixel in the liquid crystal display device according to this example. FIG. 8 illustrates the structures of the thin film transistor 115, the common electrode 103, the pixel electrode 105, and the signal line 106.

In the method of manufacturing the liquid crystal display device according to this example, a glass substrate having a thickness of 0.7 mm whose surfaces are polished is used as the glass substrate 101. On the glass substrate 101, the gate insulating film 107 for preventing the common electrode 103, the pixel electrode 105, the signal line 106, and the scanning lines 104 from being short-circuited, and the protective insulating film 108 for protecting the thin film transistor 115, the pixel electrode 105, and the signal line 106 are formed, to thereby provide a TFT substrate.

The thin film transistor 115 includes the pixel electrode (source electrode) 105, the signal line (drain electrode) 106, the scanning line (gate electrode line) 104, and the semiconductor film (amorphous silicon film) 116. The scanning line (gate electrode line) 104 is formed by patterning an aluminum film, the signal line (drain electrode) 106 is formed by patterning a chrome film, and the common electrode 103 and the pixel electrode 105 are formed by patterning an ITO film.

The gate insulating film 107 and the protective insulating film 108 were made of silicon nitride, and the respective thicknesses were set to 0.2 μm and 0.3 μm. A capacitative element was formed as a structure in which the gate insulating film 107 and the protective insulating film 108 were sandwiched between the pixel electrode 105 and the common electrode 103.

The pixel electrode 105 is so arranged as to overlap with an upper layer of the common electrode 103 having a solid shape. The number of pixels is 1024×3×768, including 1024×3 (corresponding to R, G, and B) signal lines 106 and 768 scanning lines 104.

On the glass substrate 102, the color filter layer 111 with the light shield film (black matrix) 113 is formed, to thereby provide counter color filter substrate as in Example 1.

In this example, various polyamide acid ethyl esters 5-1 to 5-3 synthesized in accordance with the raw material compositions shown in Table 5 below were used for the alignment control film 109. Then, those alignment control films were used to manufacture three liquid crystal display devices.

The polyamide acid was used to prepare a varnish with a resin concentration of 5 wt %, DMAC of 60 wt %, γ-butyrolactone of 20 wt %, and butyl cellosolve of 15 wt %. The varnish was printed on an active matrix substrate, and imidized through a heat treatment to form a dense alignment control film 109 made of a polyimide and a polyamide acid ethyl ester with an imidization ratio of about 70% and a thickness of about 90 nm.

TABLE 5

| | Amine compounds | | | |
|---|---|---|---|---|
| Alignment | Group of | Group of | Group of | Tetracarboxylic |
| control | compounds | compounds | compounds | dianhydride |
| film No. | I (mol %) | II (mol %) | III (mol %) | (mol %) |
| 5-1 | A-1 (70) | B-7 (25) | C-1 (5) | D-3 (100) |
| 5-2 | A-19 (60) | B-15 (38) | C-4 (2) | D-5 (100) |
| 5-3 | A-64 (87) | B-18 (10) | C-8 (3) | D-8 (100) |

Likewise, the same polyamide acid ethyl ester varnish was also printed on the surface of another glass substrate 102 on which an ITO film has been formed, and imidized through a heat treatment to form a dense alignment control film 109 made of a polyimide and a polyamide acid ester with an imidization ratio of about 80% and a thickness of about 110 nm.

In order to impart the liquid crystal alignment capability to the surface of the alignment control film 109, the polarized UV (ultraviolet) rays were applied onto the alignment control film 109 while irradiating the far infrared rays.

With the use of a high-pressure mercury lamp as the light source, the UV rays in a range of 240 nm to 500 nm were extracted. The extracted UV rays were linearly polarized at the polarization ratio of about 10:1 by using a pile polarizer in which quartz substrates were laminated on each other, and applied with the irradiation energy of about 2.5 J/cm². In this case, a temperature of the alignment control film was about 180° C.

As a result, it was found that the alignment direction of the liquid crystal molecules on the alignment control film surface is orthogonal to the polarization direction of the irradiated polarized UV rays.

The alignment directions of the alignment control films 109 on the TFT substrate and the color filter substrate were substantially parallel to each other. Polymer beads having an average grain diameter of 4 μm were dispersed as spacers between the substrates, and the liquid crystal molecules 110a were sandwiched between the TFT substrate and the color filter substrate.

The liquid crystal molecules 110a were made of the same liquid crystal composition A as that in Example 1.

The two polarization plates 114 that sandwich the TFT substrate and the color filter substrate were arranged in crossed nicols. A normally close characteristic in which dark display is established with a low voltage and bright display is established with a high voltage was provided.

As a result of evaluating the display quality of the liquid crystal display device according to this example, the aperture ratio was higher than that in the liquid crystal display device of Example 1, and the high-grade display of 700:1 in the contrast ratio was confirmed. Further, the wide viewing angle during the halftone display was confirmed.

Further, as a result of quantitatively evaluating the image-sticking and the residual image relaxation time of the liquid crystal display device as in Example 1, the residual image relaxation time was within 5 minutes in the use temperature range of 0° C. to 50° C., and even in the visual image quality residual image test, the sticking of the image and the display unevenness caused by the residual image were not found at all, and the high display characteristic equivalent to Example 1 was obtained.

### EXAMPLE 6

In this example, the five liquid crystal display devices were manufactured in the same manner as that in Example 5 except that various polyamide acids 6-1 to 6-5 synthesized in accordance with the raw material compositions shown in Table 6 below were used as the alignment control film 109.

TABLE 6

| | Diamine compounds | | Acid anhydrides | |
|---|---|---|---|---|
| Alignment | Group of | Group of | Group of | Tetracarboxylic |
| control | compounds | compounds | compounds | dianhydride |
| film No. | I (mol %) | II (mol %) | III (mol %) | (mol %) |
| 6-1 | A-1 (70) | B-7 (30) | C-10 (5) | D-3 (95) |
| 6-2 | A-19 (60) | B-15 (40) | C-13 (2) | D-5 (98) |
| 6-3 | A-64 (90) | B-18 (10) | C-14 (3) | D-8 (97) |
| 6-4 | A-66 (85) | B-14 (15) | C-15 (4) | D-1 (96) |
| 6-5 | A-62 (70) | B-2 (30) | C-16 (5) | D-6 (95) |

As a result of evaluating the display quality of the liquid crystal display device according to this example, the high-grade display equivalent to Example 5 was confirmed. Further, as a result of quantitatively evaluating the image-sticking and the residual image relaxation time of the liquid crystal display device as in Example 5, the residual image relaxation time was within 5 minutes in the use temperature range of 0° C. to 50° C., and even in the visual image quality residual image test, the sticking of the image and the display unevenness caused by the residual image were not found at all, and the high display characteristic equivalent to Example 5 was obtained.

### EXAMPLE 7

In this example, the five liquid crystal display devices were manufactured in the same manner as that in Example 5 except that various polyamide acid methyl esters 7-1 to 7-5 synthesized in accordance with the raw material compositions shown in Table 7 below were used as the alignment control film 109.

TABLE 7

| | |
|---|---|
| Diamine compounds | Acid anhydrides |

| Alignment | Group of | Group of | Tetracarboxylic |
|---|---|---|---|
| control | compounds I | compounds II | dianhydride |
| film No. | (mol %) | (mol %) | (mol %) |
| 7-1 | A-1 (70) | B-22 (30) | D-4 (100) |
| 7-2 | A-1 (70) | B-23 (30) | D-4 (100) |
| 7-3 | A-1 (70) | B-27 (30) | D-4 (100) |
| 7-4 | A-1 (70) | B-28 (30) | D-4 (100) |
| 7-5 | A-1 (70) | B-31 (30) | D-4 (100) |

As a result of evaluating the display quality of the liquid crystal display device according to this example, the high-grade display equivalent to Example 5 was confirmed. Further, as a result of quantitatively evaluating the image-sticking and the residual image relaxation time of the liquid crystal display device as in Example 5, the residual image relaxation time was within 5 minutes in the use temperature range of 0° C. to 50° C., and even in the visual image quality residual image test, the sticking of the image and the display unevenness caused by the residual image were not found at all, and the high display characteristic equivalent to Example 5 was obtained.

### EXAMPLE 8

In this example, the five liquid crystal display devices were manufactured in the same manner as that in Example 5 except that various polyamide acids 8-1 to 8-5 synthesized in accordance with the raw material compositions shown in Table 8 below were used as the alignment control film 109.

TABLE 8

| | |
|---|---|
| Diamine compounds | Acid anhydrides |

| Alignment | Group of | Group of | Tetracarboxylic |
|---|---|---|---|
| control | compounds I | compounds III | dianhydride |
| film No. | (mol %) | (mol %) | (mol %) |
| 8-1 | A-22 (95) | C-2 (5) | D-5 (100) |
| 8-2 | A-22 (95) | C-4 (5) | D-5 (100) |
| 8-3 | A-22 (95) | C-5 (5) | D-5 (100) |
| 8-4 | A-22 (95) | C-6 (5) | D-5 (100) |
| 8-5 | A-22 (95) | C-8 (5) | D-5 (100) |

As a result of evaluating the display quality of the liquid crystal display device according to this example, the high-grade display equivalent to Example 5 was confirmed. Further, as a result of quantitatively evaluating the image-sticking and the residual image relaxation time of the liquid crystal display device as in Example 5, the residual image relaxation time was within 5 minutes in the use temperature range of 0° C. to 50° C., and even in the visual image quality residual image test, the sticking of the image and the display unevenness caused by the residual image were not found at all, and the high display characteristic equivalent to Example 5 was obtained.

### EXAMPLE 9

In this example, the five liquid crystal display devices were manufactured in the same manner as that in Example 5 except that various polyamide acids 9-1 to 9-5 synthesized in accordance with the raw material compositions shown in Table 9 below were used as the alignment control film 109.

TABLE 9

| | |
|---|---|
| Diamine | |
| compounds | Acid anhydrides |

| Alignment | Group of | Group of | Tetracarboxylic |
|---|---|---|---|
| control | compounds I | compounds III | dianhydride |
| film No. | (mol %) | (mol %) | (mol %) |
| 9-1 | A-58 (100) | C-10 (5) | D-3 (95) |
| 9-2 | A-58 (100) | C-12 (5) | D-3 (95) |
| 9-3 | A-58 (100) | C-14 (5) | D-3 (95) |
| 9-4 | A-58 (100) | C-15 (5) | D-3 (95) |
| 9-5 | A-58 (100) | C-16 (5) | D-3 (95) |

As a result of evaluating the display quality of the liquid crystal display device according to this example, the high-grade display equivalent to Example 5 was confirmed. Further, as a result of quantitatively evaluating the image-sticking and the residual image relaxation time of the liquid crystal display device as in Example 5, the residual image relaxation time was within 5 minutes in the use temperature range of 0° C. to 50° C., and even in the visual image quality residual image test, the sticking of the image and the display unevenness caused by the residual image were not found at all, and the high display characteristic equivalent to Example 5 was obtained.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display device, comprising:
a pair of substrates, at least one of which is transparent;
a liquid crystal layer arranged between the pair of substrates;
an electrode group formed on at least one of the pair of substrates, for applying an electric field to the liquid crystal layer; and
an alignment control film arranged on at least one of the pair of substrates, wherein
the alignment control film is made of a polyimide and a polyimide precursor, and
the polyimide and the polyimide precursor have an aromatic ring and a cross-linking moiety in a main chain in chemical structure, are free from a side chain component having two or more carbon atoms in the aromatic ring, contain a cyclobutanetetracarboxylic dianhydride as a raw material, and are irradiated with light that has been substantially linearly polarized to provide an alignment regulating force.

2. A liquid crystal display device, comprising:
a pair of substrates, at least one of which is transparent;
a liquid crystal layer arranged between the pair of substrates ;
an electrode group formed on at least one of the pair of substrates, for applying an electric field to the liquid crystal layer; and
an alignment control film arranged on at least one of the pair of substrates, wherein
the alignment control film is made of a polyimide and a polyimide precursor,
the polyimide and the polyimide precursor include, as raw materials, at least one kind of diamine selected from a group of compounds I represented by the following chemical formulae (I-1) to (I-10), at least one kind of diamine selected from a group of compounds II represented by the following chemical formulae (II-1) to (II-15), and a cyclobutanetetracarboxylic dianhydride as an acid anhydride, and are irradiated with light that has been substantially linearly polarized to provide an alignment regulating force. 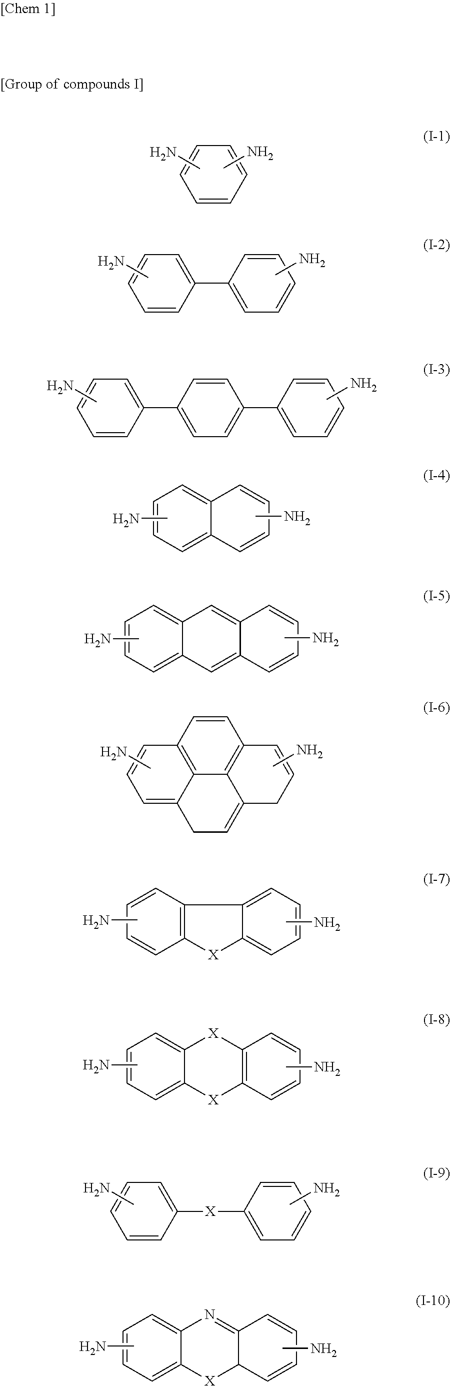
where X's each independently represent any one of the following structures: —CH₂—, —CO—, —O—, —NH—, —CO—NH—, —S—, —SO—, and —SO₂—. 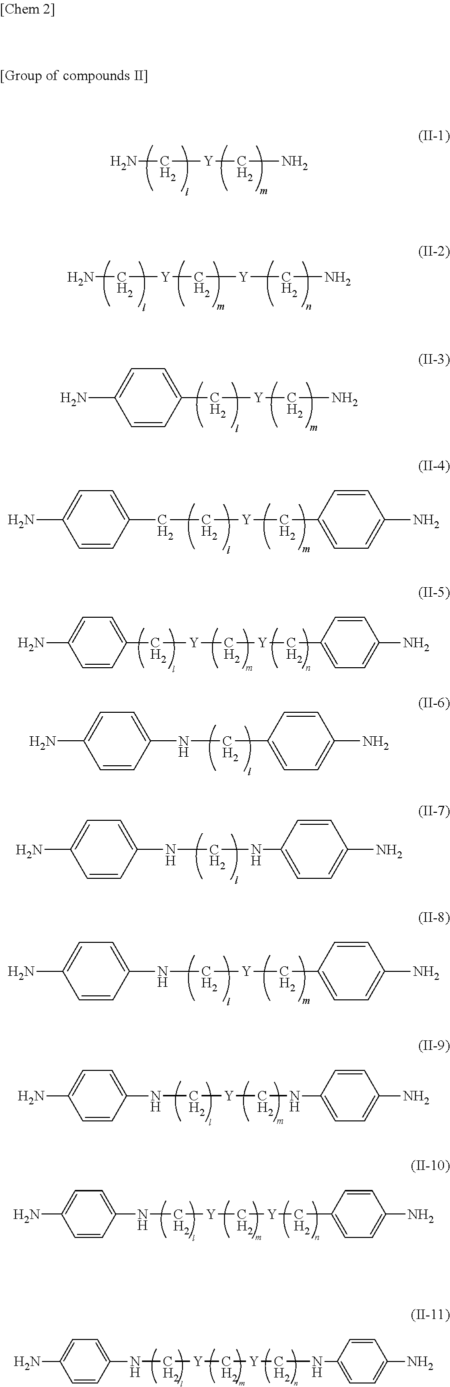 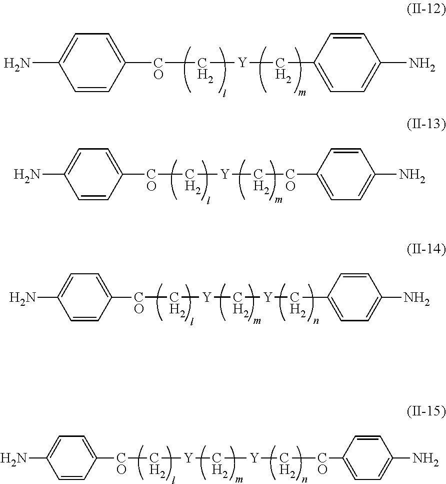
where: l's, m's, and n's each independently represent an integer of 0 to 6; and Y's each represent any one of the following structures: —NH—, —CH═CH—, —O—CH═CH—, —O—CH═CH—O—, —C≡C—, —O—C≡C—, —O—C≡C—O—, —CH═CH—COO—, and —OOC—CH═CH—COO—.

3. A liquid crystal display device, comprising:
a pair of substrates, at least one of which is transparent;
a liquid crystal layer arranged between the pair of substrates;
an electrode group formed on at least one of the pair of substrates, for applying an electric field to the liquid crystal layer; and
an alignment control film arranged on at least one of the pair of substrates, wherein
the alignment control film is made of a polyimide and a polyimide precursor, and
the polyimide and the polyimide precursor include, as raw materials, at least one kind of diamine selected from a group of compounds I represented by the following chemical formulae (I-1) to (I-10), at least one kind of compound selected from a group of compounds III represented by the following chemical formulae (III-1) to (111-6), and a cyclobutanetetracarboxylic dianhydride as an acid anhydride, and are irradiated with light that has been substantially linearly polarized to provide an alignment regulating force. 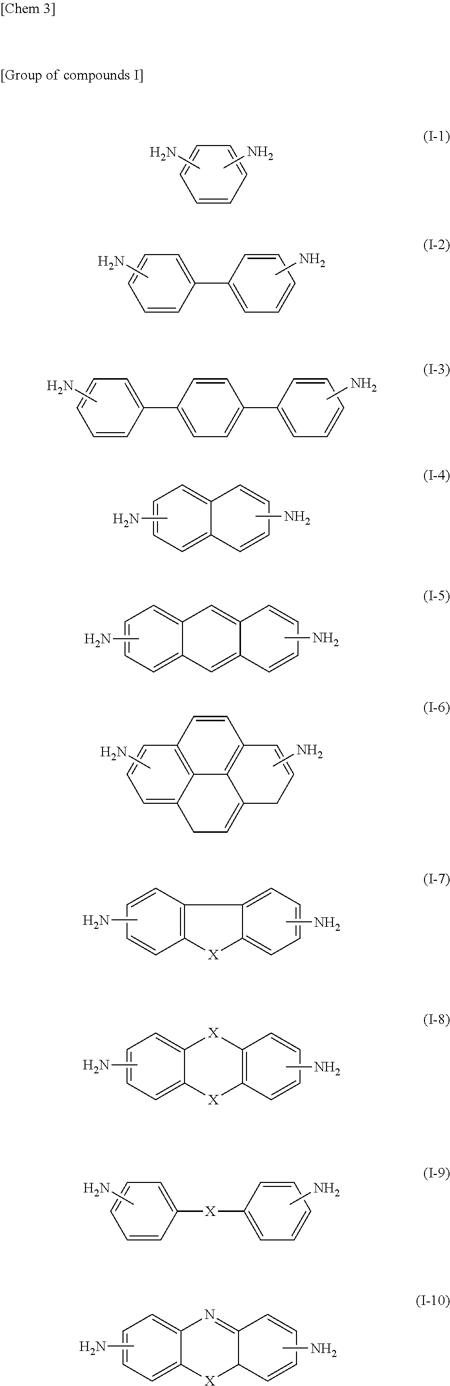
where X's each independently represent any one of the following structures: —CH₂—, —CO—, —O—, —NH—, —CO—NH—, —S—, —SO—, and —SO₂—. 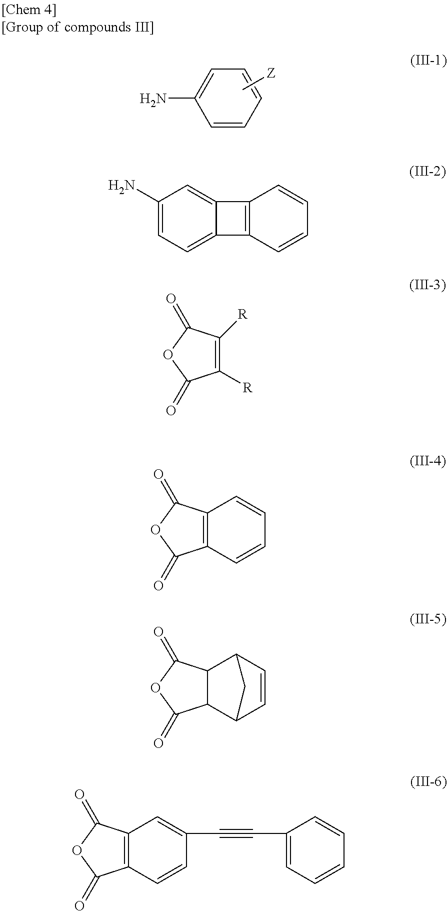
where: R's each independently represent one of a hydrogen atom, a methyl group, and a phenyl group; and Z represents any one of the following structures: a vinyl group, an alkynyl group, H₂C═CH—COO—(CH₂)ₙ— where n represents one of 0, 1, and 2, N≡C—O—, and F₂C≡CFO—.

4. The liquid crystal display device according to claim 2, wherein the polyimide and the polyimide precursor further include, as a raw material, at least one kind of compound selected from a group of compounds III represented by the following chemical formulae (III-1) to (III-6). 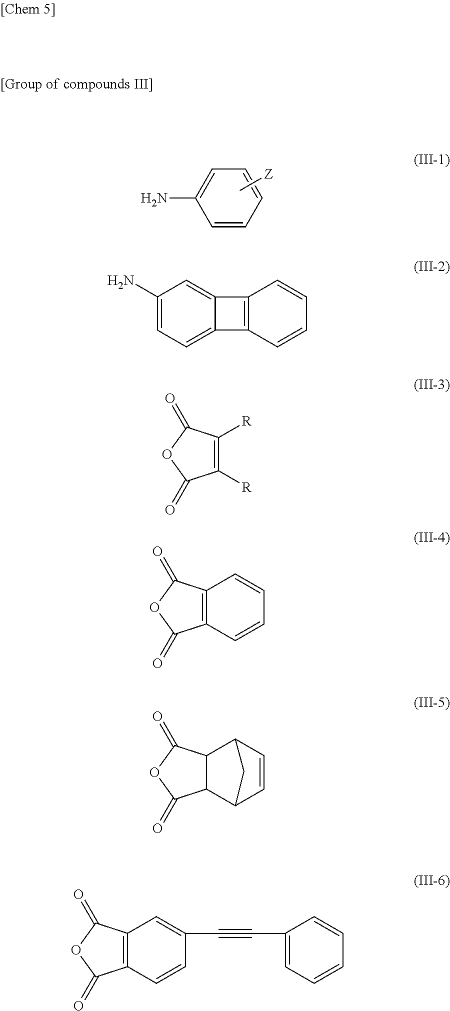
where: R's represent one of a hydrogen atom, a methyl group, and a phenyl group; and z represents any one of the following structures : a vinyl group, an alkynyl group, H₂C═CH—COO—(CH₂)ₙ— where n represents one of 0, 1, and 2, N≡C—O—, and F₂C═CFO—.

5. The liquid crystal display device according to claim 1, wherein the cyclobutanetetracarboxylic dianhydride comprises a compound represented by the following chemical formula (IV-1). 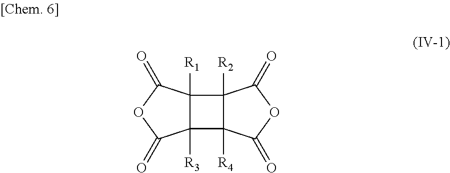
where R₁ to R₄ each independently represent one of a hydrogen atom, an alkyl group having 1 to 3 carbon atoms, and the following structure: —(CH₂)ₙ—COOH where n represents one of 0 and 1.

6. The liquid crystal display device according to claim 1, wherein the polyimide precursor comprises a polyamide acid alkyl ester having 1 to 3 carbon atoms.

7. The liquid crystal display device according to claim 1, wherein a diamine compound used as the raw material for the polyimide and the polyimide precursor contains one or more diamines selected from a group of compounds I represented by the following chemical formulae (I-1) to (I-10) at a ratio of from 50 mol % or more to 95 mol % or less. 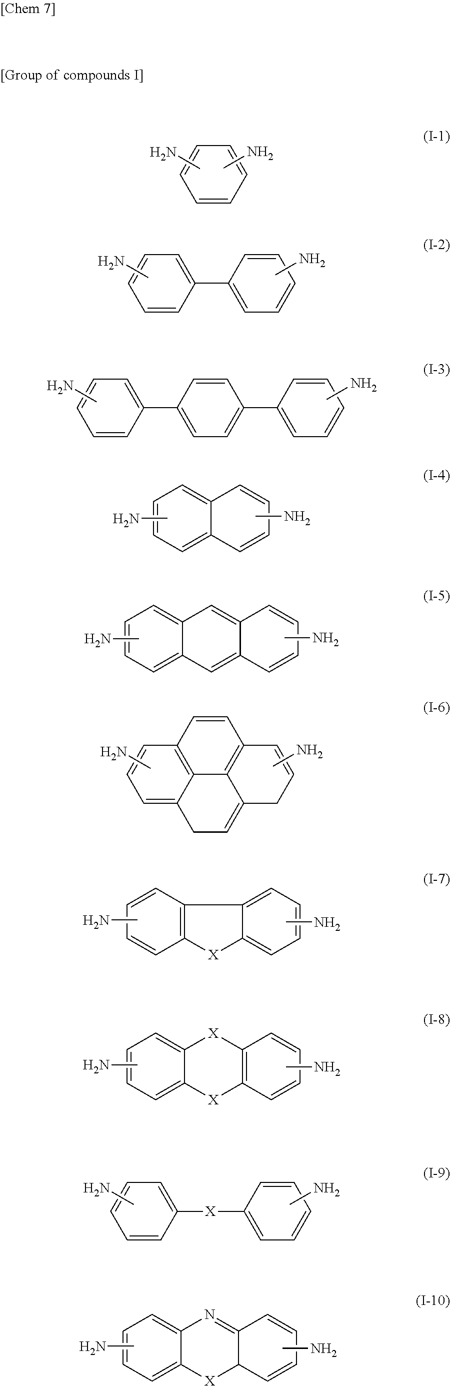
where X's each independently represent any one of the following structures: —CH₂—, —CO—, —O—, —NH—, —CO—NH—, —S—, —SO—, and —SO₂—.

8. The liquid crystal display device according to claim 1, wherein a diamine compound used as the raw material for the polyimide and the polyimide precursor contains one or more diamines selected from a group of compounds II represented by the following chemical formulae (II-1) to (II-15) at a ratio of from 5 mol % or more to 50 mol %, or less. 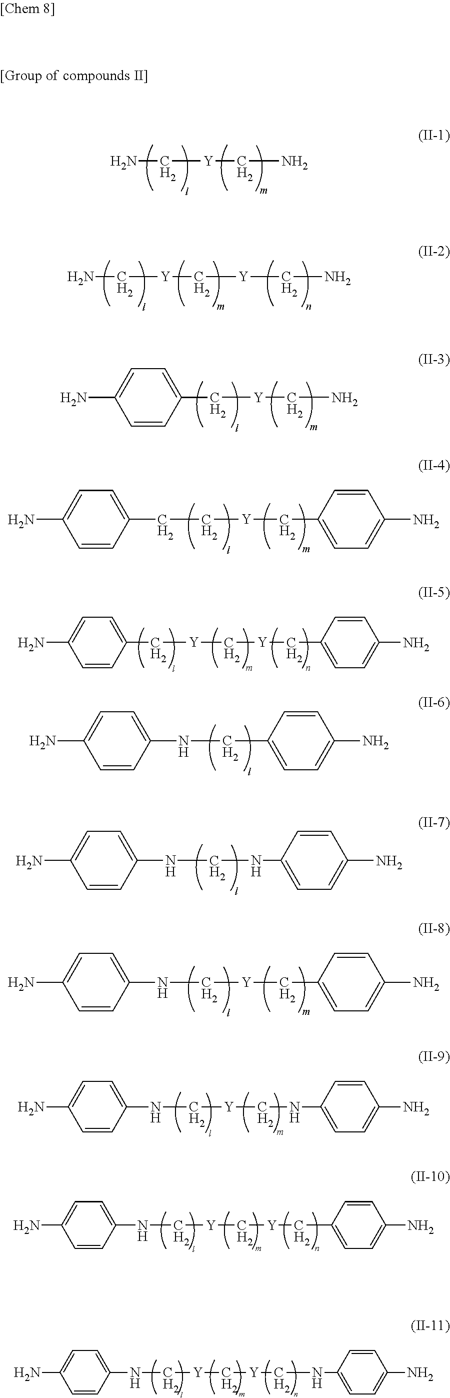 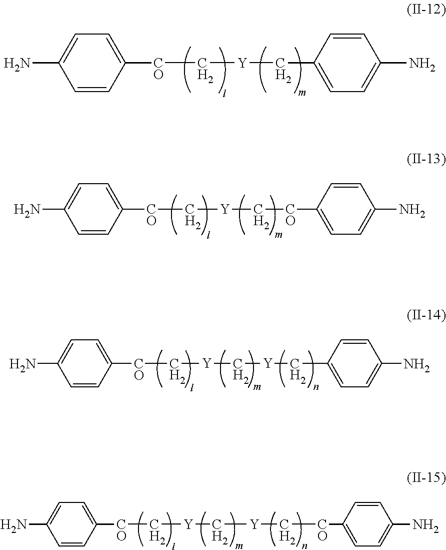
where: l's, m's, and n's each independently represent an integer of 0 to 6; and Y's each represent any one of the following structures: —NH—, —CH═CH—, —O—CH═CH—, —O—CH═CH—O—, —C≡C—, —O—C≡C—, —O—C≡C—O—, —CH═CH—COO—, and —OOC—CH═CH—COO—

9. The liquid crystal display device according to claim 1, wherein the polyimide and the polyimide precursor contain, as a raw material, one or more compounds selected from a group of compounds III represented by the following chemical formulae (III-1) to (III-6) at a ratio of from 1 mol % or more to 2.5 mol % or less. 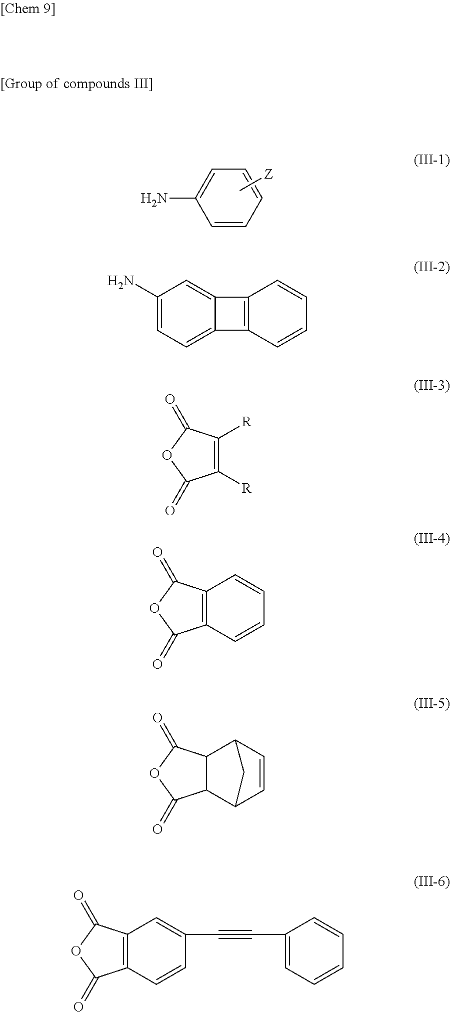
where: R's each independently represent one of a hydrogen atom, a methyl group, and a phenyl group; and Z represents any one of the following structures: a vinyl group, an alkynyl group, H₂C═CH—COO—(CH₂)ₙ— where n represents one of 0, 1, and 2, N≡C—O—, and F₂C═CFO—.

10. The liquid crystal display device according to any one of claims 1 to 6, wherein the tetracarboxylic dianhydride used as the raw material for the polyimide and the polyimide precursor contains the following cyclobutanetetracarboxylic dianhydride at a ratio of from 70 mol % or more to 100 mol % or less. 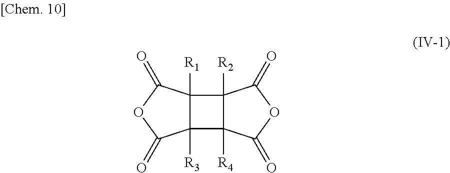
where R₁ to R₄ each independently represent one of a hydrogen atom, an alkyl group having 1 to 3 carbon atoms, and the following structure: —(CH₂)ₙ—COOH where n represents one of 0 and 1.

11. The liquid crystal display device according to claim 1, wherein the electrode group is formed on only any one of the pair of substrates.

12. The liquid crystal display device according to claim 1, wherein a pretilt angle of the liquid crystal layer is 1 degree or less.

13. The liquid crystal display device according to claim 1, wherein a hardness of the alignment control film ranges from 0.1 GPa or more to 1.0 GPa or less.

14. The liquid crystal display device according to claim 1, wherein a hardness of the alignment control film ranges from 0.2 GPa or more to 0.9 GPa or less.

15. The liquid crystal display device according to claim 1, wherein a hardness of the alignment control film ranges from 0.3 GPa or more to 0.8 GPa or less.

16. The liquid crystal display device according to claim 2, wherein the polyimide and the polyimide precursor include, as raw materials, at least two different diamines represented by the group of compounds I.

17. The liquid crystal display device according to claim 2, wherein the polyimide and the polyimide precursor include, as raw materials, at least three different diamines represented by the group of compounds I.

18. The liquid crystal display device according to claim 2, wherein the polyimide and the polyimide precursor include, as raw materials, at least two different diamines represented by the group of compounds II.

19. The liquid crystal display device according to claim 2, wherein the polyimide and the polyimide precursor include, as raw materials, at least three different diamines represented by the group of compounds II.
